(19) United States
(12) Patent Application Publication
(10) Pub. No.: US 2026/0146862 A1
(43) Pub. Date: May 28, 2026

(54) METHOD AND SYSTEM FOR GENERATING LANE-LEVEL OD PATTERN

(71) Applicant: HERE Global B.V., Eindhoven (NL)

(72) Inventor: James Adeyemi FOWE, Chicago, IL (US)

(21) Appl. No.: 18/960,988

(22) Filed: Nov. 26, 2024

(51) Int. Cl. G01C 21/36

(52) U.S. Cl. CPC G01C 21/3658; G01C 21/3691

(57) ABSTRACT

A system and method for generating demand value for lane level is disclosed. The system receives, from data sources, trip data associated with a plurality of trips. Each of the plurality of trips is associated with a lane of a link segment within a geographical region. The system determines location data associated with each of the plurality of trips based on the trip data. The location data comprises an origin location and a destination location. The system generates subsets of the plurality of trips. Each of the subsets is associated with at least one of: an origin location of each of the plurality of trips, or a destination location of each of the plurality of trips. The system generates a demand value for each of the origin locations and each of the destination locations based on the subsets. The system outputs the demand value associated with the lane.

### TECHNOLOGICAL FIELD

The present disclosure generally relates to a navigation system and more particularly relates to a system and a method for lane-level navigation using origin destination (OD) pattern data.

### BACKGROUND

In map navigation systems, analysis of real time traffic conditions and non-real time traffic analytics is performed for various use cases in transportation and logistics, route planning, identifying points of interest (POI), and road network planning. Therefore, an understanding of traffic pattern data is useful for efficient transportation planning, infrastructure development, and effective traffic management.

The map navigation systems are dependent on segment-level data for providing analytics related to traffic pattern data, which may offer a narrow view of traffic patterns along specific road segments. However, such analytics may be very limited and may not provide accurate insights needed for traffic forecasting, effective incident management, and other critical applications.

Furthermore, urban and transportation planners require detailed traffic insights to make informed decisions. Comprehensive data is essential for designing and implementing infrastructure projects and traffic regulations that may effectively address the complexities of modern urban mobility. Without a deeper understanding of traffic dynamics, planners may struggle to create solutions that meet the evolving needs of cities and their inhabitants.

Therefore, there is a need for improved systems and methods for performing analytics on traffic pattern data.

### BRIEF SUMMARY OF SOME EXAMPLE EMBODIMENTS

A system, a method, and a computer programmable product are provided for generating a demand value associated with traffic on a lane-level.

In one aspect, a system for generating lane-level demand values is disclosed. The system includes a memory configured to store computer-executable instructions, and one or more processors coupled to the memory. The one or more processors are configured to receive, from one or more data sources, trip data associated with a plurality of trips. Each of the plurality of trips is associated with a lane of a link segment within a geographical region. The one or more processors may be further configured to determine location data associated with each of the plurality of trips based on the trip data. The location data comprises an origin location and a destination location. The one or more processors may be further configured to generate one or more subsets associated with the plurality of trips. Each of the one or more subsets is associated with at least one of: an origin location from the origin location of each of the plurality of trips, a destination location from the destination location of each of the plurality of trips, or a combination thereof. Each of the one or more subsets comprises one or more trips from the plurality of trips. The one or more processors may be further configured to generate a demand value for each of the origin location of each of the plurality of trips and each of the destination location of each of the plurality of trips based on the one or more subsets. The one or more processors may be further configured to output the demand value associated with the lane.

In additional system embodiments, the one or more processors may be further configured to determine a trip count for each of the one or more subsets based on a number of the one or more of trips associated with each of the one or more subsets. Further, the one or more processors may be configured to generate OD matrix data for each of the origin location of each of the plurality of trips and each of the destination location of each of the plurality of trips, based on the trip count for each of the one or more subsets. Further, the one or more processors may be configured to output the OD matrix data for the lane of the link segment.

In additional system embodiments, the one or more processors may be configured to generate one or more first subsets associated with the origin location of each of the plurality of trips. Each of the one or more first subsets are associated with the each of the origin location of each of the plurality of trips. Further, the one or more processors may be configured to determine a trip count for each of the one or more first subsets. Further, the one or more processors may be configured to determine the demand value for each of the origin location of the plurality of trips based on the trip count of the corresponding first subset from the one or more first subsets.

In additional system embodiments, the one or more processors may be configured to generate one or more second subsets associated with the destination location of each of the plurality of trips. Each of the one or more second subsets are associated with each of the destination location of each of the plurality of the trips. Further, the one or more processors may be configured to determine a trip count for each of the one or more second subsets. Further, the one or more processors may be configured to determine the demand value for each of the destination location of the plurality of trips based on the trip count of the corresponding second subset from the one or more second subsets.

In additional system embodiments, the one or more processors may be configured to determine an origin-destination (OD) pair from the plurality of trips based on the location data. Further, the one or more processors may be configured to generate the one or more subsets of the one or more trips based on each of the OD pairs associated with each of the plurality of trips.

In additional system embodiments, the one or more processors may be configured to generate one or more third subsets associated with the OD pair for each of the plurality of the trips. Each of the one or more third subsets are associated with each OD pair of each of the plurality of trips. Further, the one or more processors may be configured to determine a trip count for each of the one or more third subsets. Further, the one or more processors may be configured to determine a demand value for each of the OD pair of each of the plurality of trips based on the trip count of the corresponding third subset from the one or more third subsets.

In additional system embodiments, the one or more processors may be configured to rank at least one of: each of the origin location of each of the plurality of trips, each of the destination location of each of the plurality of trips, or each of the OD pairs based on the demand value. Further, the one or more processors may be configured to generate one or more sets of ranked results based on the ranking. Each of the one or more sets of ranked results comprises a corresponding sequence associated with at least one of: origin location, destination location, or OD pairs.

In additional system embodiments, the one or more processors may be configured to receive map data indicating lane information associated with the link segment. Further, the one or more processors may be configured to identify the one or more trips from the plurality of trips associated with the lane of the link segment based on the trip data and the map data.

In additional system embodiments, the one or more trips are associated with a predefined historical time period. The one or more processors may be configured to determine a total trip count of the lane for the predefined historical time period based on the plurality of trips. Further, the one or more processors may be configured to output the determined total trip count for the lane.

In additional system embodiments, the one or more trips are associated with a predefined historical time period, and the one or more processors are further configured to determine travel time data associated with each of the plurality of trips based on the trip data. Further, the one or more processors may be configured to determine average travel time for the lane during the predefined historical time period based on the determined travel time data.

In additional system embodiments, the link segment comprises a plurality of lanes, and the one or more processors are further configured generate a demand value for each of the origin locations of each of the plurality of trips and each of the destination locations of each of the plurality of trips associated with each of the plurality of lanes.

In additional system embodiments, the link segment comprises a plurality of lanes, and the one or more processors are further configured to obtain vehicle data of a vehicle associated with the link segment. Further, the one or more processors may be configured to generate navigation instructions for the vehicle based on the demand value for each of the origin location of the plurality of trips and each of the destination location of the plurality of trips associated with each of the plurality of lanes.

In additional system embodiments, the one or more processors are further configured to identify the one or more trips from the plurality of trips associated with the lane using a lane-level map matcher model.

In another aspect, a method of generating lane-level demand values is disclosed. The method includes receiving, from one or more data sources, trip data associated with a plurality of trips. Each of the plurality of trips is associated with a lane of a link segment within a geographical region. The method further includes determining location data associated with each of the plurality of trips based on the trip data. The location data comprises an origin location and a destination location. The method further includes generating one or more subsets associated with the plurality of trips. Each of the one or more subsets is associated with at least one of: an origin location from the origin location of each of the plurality of trips, a destination location from the destination location of each of the plurality of trips, or a combination thereof. Each of the one or more subsets comprises one or more trips from the plurality of trips. The method further includes generating demand value for each of the origin location of each of the plurality of trips and each of the destination location of each of the plurality of trips based on the one or more subsets. The method further includes outputting the demand value associated with the lane.

In additional method embodiments, the method includes generating one or more first subsets associated with the origin location of each of the plurality of trips. Each of the one or more first subsets are associated with the each of the origin location of each of the plurality of trips. The method further includes determining a trip count for each of the one or more first subsets. The method further includes determining the demand value for each of the origin location of the plurality of trips based on the trip count of the corresponding first subset from the one or more first subsets.

In additional method embodiments, the method includes generating one or more second subsets associated with the destination location of each of the plurality of trips. Each of the one or more second subsets are associated with each of the destination location of each of the plurality of the trips. The method further includes determining a trip count for each of the one or more second subsets. The method further includes determining the demand value for each of the destination location of the plurality of trips based on the trip count of the corresponding second subset from the one or more second subsets.

In additional method embodiments, the method includes determining a trip count for each of the one or more subsets based on the at least one trip associated with each of the one or more subsets. The method further includes generating the demand value for each of the origin location of the plurality of trips and each of the destination location of the plurality of trips based on the trip count for each of the one or more subsets. The method further includes outputting the at least one of: the origin location, or the destination location for the lane in association with the trip count of a corresponding subset from the one or more subsets.

In additional method embodiments, the method includes determining one or more OD pairs associated with the plurality of trips based on the location data. The method further includes generating one or more third subsets associated with the OD pair for each of the plurality of the trips. Each of the one or more third subsets are associated with each OD pair of each of the plurality of trips. The method further includes determining a trip count for each of the one or more third subsets. The method further includes determining a demand value for each of the OD pair of each of the plurality of trips based on the trip count of the corresponding third subset from the one or more third subsets.

In additional method embodiments, the method includes ranking at least one of: each of the origin location of each of the plurality of trips, each of the destination location of each of the plurality of trips, or each of the OD pairs based on the demand value. The method further comprising generating one or more sets of ranked results based on the ranking, wherein each of the one or more sets of ranked results comprises a corresponding sequence associated with at least one of: origin location, destination location, or OD pairs.

In yet another aspect, a computer program product comprising a non-transitory computer readable medium having stored thereon computer executable instructions which when executed by at least one processor, cause the processor to carry out operations for generating lane-level demand values, is provided. The operations include receiving, from one or more data sources, trip data associated with a plurality of trips. Each of the plurality of trips is associated with a lane of a link segment within a geographical region. The operations include determining location data associated with each of the plurality of trips based on the trip data. The location data comprises an origin location and a destination location. The operations include generating one or more subsets associated with the plurality of trips. Each of the one or more subsets is associated with at least one of: an origin location from the origin location of each of the plurality of trips, a destination location from the destination location of each of the plurality of trips, or a combination thereof. Each of the one or more subsets comprises one or more trips from the plurality of trips. The operations include generating demand value for each of the origin location of each of the plurality of trips and each of the destination location of each of the plurality of trips based on the one or more subsets. The operations include outputting the demand value associated with the lane.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 is a diagram that illustrates a network environment for generating demand value associated with lane in accordance with an embodiment of the disclosure;

FIG. 2 illustrates a block diagram of the system of FIG. 1, in accordance with an embodiment of the disclosure;

FIG. 3 is a diagram that illustrates one or more link segments of a geographical region, in accordance with an embodiment of the disclosure;

FIG. 4 illustrates a flow diagram of a method for determining plurality of trips associated with a lane of a link segment, in accordance with an embodiment of the disclosure;

FIG. 5A illustrates a flow diagram of a method for determining demand values for an origin location, in accordance with an embodiment of the disclosure;

FIG. 5B illustrates a flow diagram of a method for determining demand values for a destination location, in accordance with an embodiment of the disclosure;

FIG. 5C illustrates a flow diagram of a method for determining demand values for OD pairs, in accordance with an embodiment of the disclosure;

FIG. 5D illustrates a diagram that shows plurality of trips between an origin and a destination, in accordance with an embodiment of the disclosure;

FIG. 6A illustrates a flow diagram of a method for outputting origin, destination and OD pairs, in accordance with an embodiment of the disclosure;

FIG. 6B illustrates a schematic diagram of OD matrix data, in accordance with an embodiment of the disclosure;

FIG. 7 illustrates a flow diagram of a method for generating navigation instructions for a vehicle, according to one or more example embodiments of the disclosure;

FIG. 8 illustrates a flowchart that illustrates an exemplary method for generating lane-level demand values, in accordance with an embodiment of the disclosure;

FIG. 9 illustrates an exemplar map database record storing data, in accordance with one or more example embodiments;

FIG. 10 illustrates another exemplar map database record storing data, in accordance with one or more example embodiments; and

FIG. 11 illustrates another exemplar map database storing data, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

One challenge facing current transportation systems is the increasing complexity of roads and lanes. This complexity arises from the rise of multi-modal transportation, which has led to a growing demand for dedicated lanes for bicycles, buses, scooters, delivery robots, and more. City and transportation planners face a significant challenge in understanding the impact of changes to road lanes, such as reducing or increasing the number of lanes, temporarily removing a lane, or converting a lane to a different transportation mode, like a bus lane. Accurately predicting the city-wide effects on routes and origin-destination (OD) pairs is crucial for informed decision-making. However, the complexity of modern transportation systems, which encompass multiple modes and competing demands for limited road space, complicates the ability to forecast the consequences of these lane modifications effectively. Furthermore, being able to identify the specific uses of individual lanes and distinguish their distinct purposes in facilitating the movement of people and goods is invaluable for effective planning. This information may enhance advertising strategies and improve services for both passengers and other entities utilizing the roadway.

Conventional methods of traffic analysis often lack lane-level resolution, meaning they do not differentiate between individual lanes within a road segment. Each lane can display unique traffic behaviors, such as varying speeds, densities, and specific purposes (e.g., turning lanes). This absence of detailed data decreases the accuracy of traffic analysis. Moreover, without lane-specific information, traffic prediction models may yield inaccurate results, as congestion in a single lane may not be adequately captured by segment-level data. This can lead to suboptimal traffic management decisions and forecasting errors. Additionally, real-time applications such as dynamic lane management, incident detection, and targeted advertising require precise lane-level data to operate effectively.

The present disclosure may provide significant technical improvement by providing the granularity and accuracy needed for effective real-time traffic management strategies. The present disclosure utilizes a lane-level map-matcher to refine the map-matching process and generate precise lane-level traffic patterns, thereby enabling more accurate, actionable insights for various applications. Systems and methods are provided herein that may use probe data from a plurality of vehicles to perform lane-level analytics in terms of where vehicles come from (upstream OD analytics) and where they go (downstream OD analytics). The term OD may refer to a specific pair of locations in transportation and travel analysis, where one location is designated as the origin (where a trip begins) and the other as the destination (where a trip ends). OD pairs are commonly used in various fields such as transportation planning, traffic engineering, and logistics to analyze travel patterns, estimate demand for transportation services, and improve traffic management. The lane-level analytics provide an understanding of both the microscopic OD (intermediate OD along route) and macroscopic OD (covering longer distances or original start and end of journey). The lane-level analytics may be used to anticipate present and future traffic patterns, for example the demand to be placed on each lane in the future. The analysis can be utilized to assess lane usage during trips into, within, and through an area. It can also capture factors such as the time of day, mode of travel, and the number of occupants in a vehicle during a trip. This information helps to identify current travel patterns, pinpoint areas that generate the most traffic, and evaluate the efficiency of traffic lanes in terms of flow and safety. Additionally, it allows for an assessment of the overall road plan and identification of present or potential issues. By determining the need for revised flow patterns, alternative routes, new streets, and parking areas, the analysis may also aid in understanding parking patterns in major functional areas. Ultimately, being aware of future projects or changes enables planners to anticipate shifts in travel patterns, helping to avoid potential traffic problems.

The present disclosure may provide a system, a method, and a computer programmable product for ranking a popular origin, a destination, and OD pair. The system in the present disclosure may use a machine learning (ML) model to determine traffic data associated with the lane of a link segment.

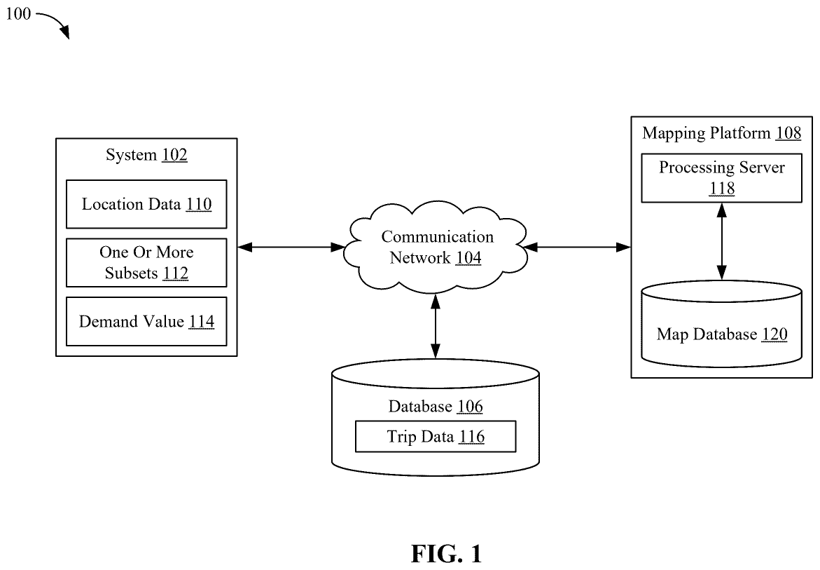

FIG. 1 illustrates a network environment 100 in which a system 102 for generating lane-level demand value of traffic associated with the lane is implemented, in accordance with an embodiment of the present disclosure. The network environment 100 includes the system 102, a communication network 104, a database 106, and a mapping platform 108. The system 102 may further include location data 110, one or more subsets 112, and a demand value 114. The mapping platform 108 may further include a processing server 118, and a map database 120. The database 106 may further store the trip data 116.

Pursuant to the present disclosure, a trip may be referred to as a journey taken by a vehicle from an origin location to a destination location within a transportation network. The trip may encompass the entire route traveled, including all intermediate stops and paths. The trip may be identified by GPS coordinates associated with each of the origin location, the destination location and the intermediate stops, timestamps indicating departure and arrival times, and data associated with speed, direction, and travel duration for completing the trip.

In an embodiment, the trip data 116 may refer to detailed information that describes the movement of the vehicle from one location to another location within the transportation network. For example, the trip data 116 is data of a trip undertaken by the vehicle from the origin location to the destination location, as mentioned above. The trip data 116 may be collected through various means, such as through a GPS device, one or more vehicle sensors, a mobile application or from centralized database such as, but not limited to the database 106. The trip data 116 is essential to analyze traffic patterns, managing transportation systems and optimizing travel routes. The trip data 116 may include the information of intermediate GPS points that outline the vehicle's path throughout the trip. Further the trip data 116 may include the exact time when the trip began and the time when the trip is concluded and also timestamps associated with each GPS coordinate collected during the trip. Further the trip data 116 may include the speed of the vehicle at various points during the trip and direction of travel at different points, often measured in degrees. Further the trip data 116 may include additional metadata such as road condition, traffic incident, weather conditions and vehicle status.

The trip data 116 may be indicative of or used in deriving metadata for a geographical region. The geographical region may refer to a defined area of the earth's surface that is distinguished by specific physical, cultural, or administrative characteristics. The geographical region may vary in size from a small neighborhood to an entire city and is often delineated based on natural boundaries such as rivers, mountains, or climate zones or human-made boundaries such as political borders, or economic zones.

In an embodiment, the system 102 may be communicatively coupled to other components not shown in FIG. 1 via the communication network 104. All the components in the network environment 100 may be coupled directly or indirectly to the communication network 104. The components described in the network environment 100 may be further broken down into more than one component and/or combined together in any suitable arrangement. Further, one or more components may be rearranged, changed, added, and/or removed.

In an example embodiment, the system 102 may be the processing server 118 of the mapping platform 108 and therefore may be co-located with or within the mapping platform 108. In another example embodiment, the database 106 may be configured to receive, store, and transmit data that may be collected from vehicles, and/or other databases associated with users, and vehicles. In accordance with an embodiment, the database 106 may be the map database 120 of the mapping platform 108 and therefore may be co-located with or within the mapping platform 108. The system 102 may comprise suitable logic, circuitry, and interfaces that may be configured to predict demand value associated with the lane of the link segment.

The embodiments disclosed herein provide the system 102 to output the demand value 114 associated with the lane. The demand value 114 associated with the lane may indicate a quantitative measure that represents the level of traffic, or the number of trips originating or destined for a specific lane within the link segment. Embodiments of the present disclosure provide techniques to accurately generate the demand value 114 associated with the lane of the link segment. The present disclosure generates the demand value 114 based on usage patterns and operational characteristics of each of the lane associated with the link segment. Some embodiments disclose methods and systems to optimize the utilization of each lane associated with the link segment by outputting the generated demand value 114 to the user to travel on the most efficient route or less congested lane of the link segment, thereby enhancing the overall user experience and efficiency of transport network infrastructure.

In an example, the system 102 may be connected to the vehicle via a vehicle communication system and the communication network 104. The vehicle may utilize the demand value 114 associated with the lane for generating optimized navigation instructions.

In operation, the system 102 may be configured to receive, from one or more data sources, the trip data 116 associated with a plurality of trips, wherein each of the plurality of trips is associated with the lane of the link segment within a geographical region. In an embodiment, the system 102 is configured to receive the trip data 116 from the one or more data sources. For example, the one or more data sources may be used for ensuring comprehensive data collection for accurate traffic analysis. For example, the one or more data sources may be the database 106 that aggregates the trip data 116 from various providers, such as, but not limited to transportation authorities, ride-sharing companies, and fleet management systems. In another example, the one or more data sources may include a server which receives input from the vehicle communication system. The vehicle communication system may receive data from the one or more sensors associated with the vehicle.

In one exemplary embodiment, the system 102 is configured to receive the trip data 116 associated with the plurality of trips. In an example, the trip data 116 includes the data associated with a plurality of vehicles that may be used to analyze traffic conditions of the link segment. In an exemplary embodiment, the system 102 may receive the trip data 116 from the database 106. For example, the system 102 may receive past 3-month trip data from the database 106. In another exemplary embodiment, the system 102 may receive the trip data 116 from the vehicle communication system in real-time. The vehicle communication system may receive trip data 116 from the one or more sensors associated with the vehicle. For instance, the one or more sensors such as, but not limited to, a Global Navigation Satellite system (GNSS) sensor, or a speed sensor. Examples of the system 102 may include, but are not limited to, an electronic control unit (ECU), an electronic control module (ECM), a computing device, a mainframe machine, a server, a computer workstation, any and/or any other device with traffic data generation operations. In an embodiment, each of the plurality of trips is associated with the lane of the link segment within the geographical region. In an example, the plurality of trips may refer to the large number of individual trips undertaken by the plurality of vehicles between the one or more locations associated with the lane of the link segment within the geographical region. For example, the link segment is a distinct section of a roadway, such as but not limited to a specific block of a city street, a stretch of a highway, or a segment of an avenue that lies between two intersections. In another example, the term geographical region may refer to a defined area of land characterized by specific geographic boundaries, features, or attributes. The geographical region may vary in size and scale, ranging from small local neighbourhoods to larger regions such as cities, states, or even countries. In the context of transportation and travel analysis, a geographical region typically encompasses the region within which travel patterns, traffic flows, or transportation systems are studied and analysed.

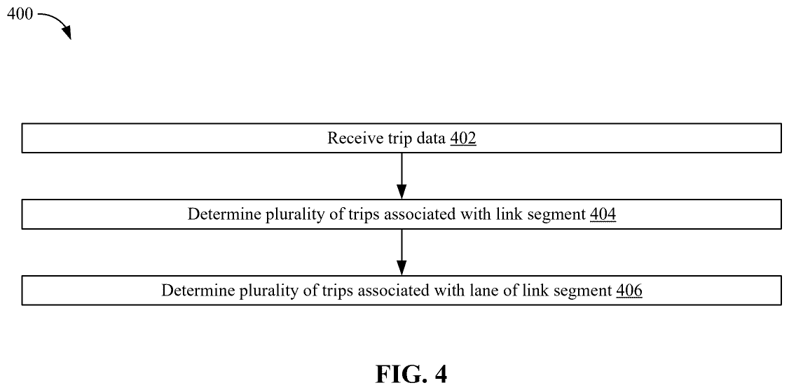

In another exemplary embodiment, each of the plurality of trips is associated with a specific lane of the link segment within the geographical region. For instance, the lanes are designated portions of the link segment that guide and regulate the movement of the vehicle. Each lane is typically marked by painted lines and may serve a specific function to ensure orderly traffic flow to improve safety and optimized link capacity. The lane may be of different types such as, but not limited to, a driving lane that is used for regular vehicle travel, passing lanes that are designated for overtaking slower vehicles, turning lanes that are specifically for making left or right turn at intersections, bicycle lane, and bus lane. For example, the system 102 may employ advanced map-matching techniques such as lane-level map-matcher to accurately associate each trip with specific lane within the link segment. The lane-level map matcher is an algorithm that is used to accurately align real-time vehicle trajectory data with specific lanes on a digital map. This process begins with the collection of data from various sources which track the vehicle's position, speed, and direction of travel. The algorithm relies on high-resolution digital maps that provide detailed information about the road network, including lane configurations, widths, and other attributes. The lane-level map matcher algorithm processes the collected data, comparing it against the digital map to determine the precise lane that the vehicle is traversing. This algorithm analyses factors such as the vehicle's trajectory and speed, as well as its proximity to lane boundaries, to ensure an accurate match. Further detail is provided in FIG. 4.

Further the system 102 is configured to determine the location data 110 associated with each of the plurality of trips based on the trip data 116. In an embodiment, the system 102 is configured to determine the location data 110 associated with each of the plurality of the trips associated with the lane of the link segment. For example, the system 102 may analyze the trip data 116 to extract specific geographical information about the each of the plurality of trips traversed by each vehicle. For instance, each of the plurality of trips received from the one or more data sources in the database 106 may include a series of GPS coordinates that trace the vehicle's route. The system 102 processes the trip data 116 to determine the location data 110 for each of the lane associated with the link segment.

The location data 110 comprises the origin location and the destination location. In an embodiment, the system 102 is configured to determine the location data 110 which includes the origin location and the destination location for each trip from the plurality of trips. The origin location is the starting point where the trip begins, while the destination location may be the endpoint where the trip concluded. By identifying the origin location and the destination location, the system 102 may map out the beginning and ending points of each trip, providing a clear picture of travel patterns.

Further the system 102 is configured to generate the one or more subsets 112 associated with the plurality of trips. Each of the one or more subsets 112 is associated with at least one of: an origin location from the origin location of each of the plurality of trips, a destination location from the destination location of each of the plurality of trips, or a combination thereof. In an example, the system 102 is configured to generate one or more subsets 112 from a set which include the plurality of trips, where each of the one or more subsets 112 is associated with at least one of the origin locations from the one or more origin locations associated with the plurality of trips, or the destination location from the one or more destination locations associated with the plurality of trips. The system 102 is configured to analyze the location data 110 to group trips based on the common origin or common destination locations. For example, after determining the location data 110 for each of the plurality of trips associated with the specific lane of the link segment, the system 102 categorizes each of the plurality of trips by their respective origin locations, and the respective destination locations. Each of the one or more subsets 112 may include the one or more trips that share a common origin location, a common destination location, or both.

Moreover, each of the one or more subsets 112 comprises one or more trips from the plurality of trips. In an example, the system 102 analyzes the plurality of trips on the link segment of a busy urban avenue. The system 102 may identify one or more trips being traversed on the lane of the link segment. The one or more trips from the plurality of trips may originate from a location A of the lane, or one or more trips from the plurality of trips on the lane of the link segment which terminate on location B. Further the system 102 is configured to generate a subset of one or more trips which originate from the location A, and generate a subset of one or more trips terminating on the location B. By generating the one or more subsets 112, the system 102 may provide a detailed breakdown of the travel pattern on each lane associated with the link segment.

Further the system 102 is configured to generate the demand value 114 for each of the origin location of each of the plurality of trips and each of the destination location of each of the plurality of trips based on the one or more subsets 112. In an exemplary embodiment, the system 102 may configured to determine the frequency or volume of the one or more trips associated with each origin location from the origin location of each of the plurality of trips. In another exemplary embodiment, the system 102 is further configured to determine the frequency or volume of the one or more trips associated with each respective destination location from the one or more destination locations providing the quantitative measure of demands for the lane associated with the link segment.

For example, after generating the one or more subsets 112 of the one or more trips, the system 102 is further configured to evaluate the number of trips in each of the one or more subsets 112. If the number of one or more trips originated from the location A of the lane associated with the link segment has a high number of trips, then the demand value 114 associated with origin location A will be high, indicating high volume of the one or more trips are originating from the origin location A

Further, the system 102 may be configured to output the demand value 114 associated with the lane of the link segment. In an embodiment, the system 102 may be configured to output the generated demand value 114 associated with each of the plurality of lanes of the link segment to user devices associated with the respective users traversing on the link segment. In another embodiment, the generated demand value 114 may be transmitted to the mapping platform 108 for further processing.

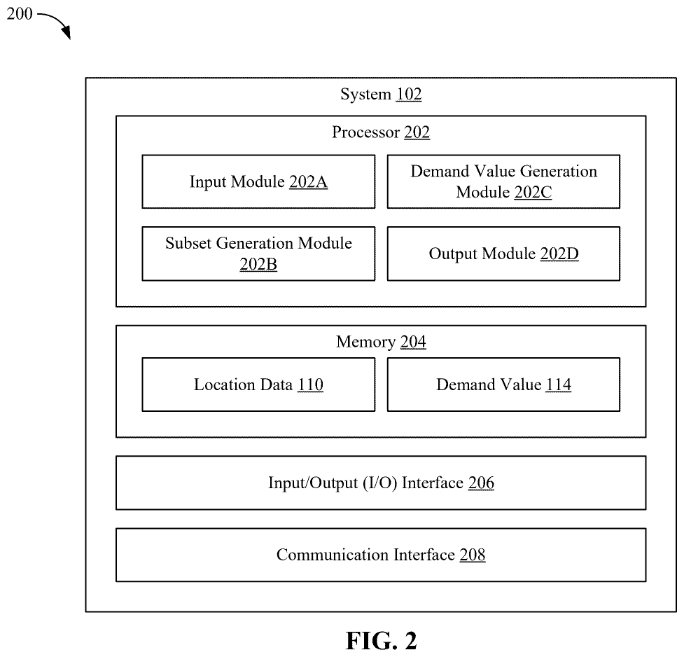

FIG. 2 illustrates a block diagram 200 of the system 102 of FIG. 1, in accordance with an embodiment of the disclosure. FIG. 2 is explained in conjunction with FIG. 1. In FIG. 2, there is shown the block diagram 200 of the system 102. The system 102 may include at least one processor 202 (referred to as a processor 202, hereinafter), at least one non-transitory memory 204 (referred to as a memory 204, hereinafter), an input/output (I/O) interface 206, and a communication interface 208. The processor 202 may comprise modules, depicted as, an input module 202A, a subset generation module 202B, a demand value generation module 202C, and an output module 202D. The processor 202 may be connected to the memory 204, and the I/O interface 206 through wired or wireless connections. Although in FIG. 2, it is shown that the system 102 includes the processor 202, the memory 204, and the I/O interface 206 however, the disclosure may not be so limiting and the system 102 may include fewer or more components to perform the same or other functions of the system 102.

In an embodiment, the input module 202A, and the output module 202D may be integrated within the I/O interface 206. In some embodiments, the input module 202A may receive input data and the output module 202D may output processed data (such as demand values, navigation instructions, and the like) via the I/O interface 206.

In accordance with an embodiment, the system 102 may store data, that may be generated by the modules while performing corresponding operations or may be retrieved from a database associated with the system 102, such as the map database 120, in the memory 204. For example, the memory 204 may store the trip data 116 that may include trajectory data, traffic data, speed value, and timestamp associated with the vehicle.

The processor 202 of the system 102 may be configured to perform one or more operations associated with generating the demand value associated with the lane. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment 100 may be accessed using a communication interface 208 of the system 102. The communication interface 208 may provide an interface for accessing various features and data stored in the system 102.

The input module 202A of the processor 202 is configured to receive the trip data 116 associated with the lane of the link segment within the geographical region. The trip data 116 may be received from the one or more data sources. In an embodiment, the input module 202A may be configured to receive the trip data 116 indicating the location of the vehicle associated with the link segment. In an embodiment, the location information may be obtained from the one or more sensors. In another embodiment, the one or more sensors may be associated with the vehicle. For example, the one or more sensors may include one or more image sensors, one or more LIDARs, one or more speed sensors, one or more global positioning sensors (GPS), and the like. In another embodiment, the input module 202A may be configured to receive trip data 116 from, for example, the database 106, and/or other databases associated with the system 102, and a navigation or delivery operation service provider, etc.

The subset generation module 202B of the processor 202 may generate one or more subsets 112 of the one or more trips from the plurality of trips associated with the lane of the link segment. In an exemplary embodiment, the subset generation module 202B may first analyze the location data 110 to identify the unique origin location and destination location on the lane associated with the link segment. The subset generation module 202B may be configured to determine the one or more trips originating from an origin location from one or more origin locations in the lane of the link segment, and one or more trips terminating at the destination location of the one or more destination locations. Further, the subset generation module 202B may be configured to generate one or more subsets 112 for each of the unique origin location from the one or more origin locations. Further, the subset generation module 202B may be configured to generate one or more subsets 112 for each of the unique destination location from the one or more destination locations. Further, the subset generation module 202B may be configured to generate one or more subsets 112 associated with the plurality of trips having same origin location and same destination location.

The demand value generation module 202C of the processor 202 is configured to generate the demand value 114 of each of the origin location of the plurality of trips and each of the destination location of the plurality of trips based on the one or more subsets 112. In an example, the demand value generation module 202C may receive input from the subset generation module 202B which has already categorized each of the plurality of trips into subsets based on the shared origin, and the destination location. For each of the one or more subsets 112, the demand value generation module 202C calculates the demand value 114. The demand value 114 may indicate the frequency or volume of trips associated with each origin location, each destination location, and OD pairs. The demand value generation module 202C counts the number of trips within each subset providing a quantitative measure of the travel demand in each lane associated with the link segment.

The output module 202D of the processor 202 may be configured to output the demand value 114 associated with each of the lane of the link segment. In an embodiment, the output module 202D may be configured to output and transmit the demand value 114 to a down-stream application, such as a navigation application. In another example, the output module 202D may output the demand value 114 for display or storage within the database 106. In certain cases, demand value 114 may be output as audio alerts informing the most popular origin location, most popular destination location and most popular origin destination pair.

The memory 204 may further store the location data 110, and the demand value 114. The memory 204 may also store the one or more subsets 112 and other information or data that may be generated by the system 102 or the processor 202 during its operation. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various operations in accordance with embodiments of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In some example embodiments, the memory 204 may store the location data 110. The location data 110 may comprise geographic information essential for accurately analyzing and managing traffic flows and transportation dynamics across designated areas. The location data 110 may include precise geospatial coordinate, detailing latitude and longitude positions of the origin location and the destination location, the location data 110 is indispensable for pinpointing the exact start and end point of each of the plurality of trips, facilitating accurate mapping of trip routes.

Moreover, the memory 204 may store comprehensive details about the lane-level attributes within the link segments, this may include information of individual lanes, their directional flow patterns, physical significance, and any associated operational restrictions or regulatory guidelines. Additionally, the stored data encompasses historical traffic conditions and real-time updates, enabling the system 102 to access current congestion levels, predicting traffic trends, and support proactive decision-making in traffic management. The location data 110 may also support the generation of accurate maps, route planning algorithm, and navigation instructions, ensuring efficient travel and enhancing overall transport efficiency.

In some example embodiment, the memory 204 may store the demand value 114. The stored demand value 114 represents quantitative metrics that denote the level of demands or usage of the origin, the destination and the OD pairs associated with the each of the plurality of lanes of the link segment. By storing the demand value 114, the system 102 may gain the capability to perform in-depth traffic analysis and pattern recognition. The system 102 may identify which location in the lane experiences the highest traffic volumes.

In some example embodiments, the I/O interface 206 may communicate with the system 102 and display and input and/or output devices of the system 102. As such, the I/O interface 206 may include a display and, in some embodiments, may also include a keyboard, a mouse, a touch screen, touch areas, soft keys, or other input/output mechanisms. In one embodiment, the system 102 may include a user interface circuitry configured to control at least some functions of one or more I/O interface elements such as the display and, in some embodiments, a plurality of speakers, a ringer, one or more microphones and/or the like. The processor 202 and/or the I/O interface 206 circuitry including the processor 202 may be configured to control one or more operations of one or more I/O interface elements through computer program instructions (for example, software and/or firmware) stored on the memory 204 accessible to the processor 202. The processor 202 may further cause rendering of notifications associated with the navigation instructions, such as traffic data, traffic conditions, traffic congestion value, ETA, routing information, road conditions, driving instructions, etc., on the user equipment or audio or display onboard the vehicles via the I/O interface 206.

The communication interface 208 may include the input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning.

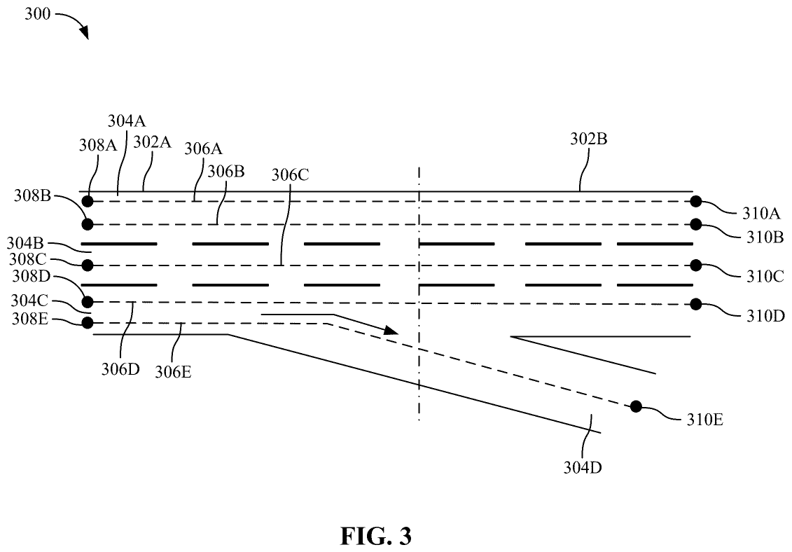

FIG. 3 is a diagram 300 that illustrates the one or more link segments within the geographical region, in accordance with an embodiment of the disclosure. FIG. 3 is explained in conjunction with elements from FIG. 1, and FIG. 2. With reference to FIG. 3, there is shown the diagram 300 that illustrates a first link segment 302A, and a second link segment 302B.

The system 102 is configured to receive the trip data 116 from the one or more sources, such as vehicle sensors, mobile sensors, mobile application and database 106. The trip data 116 may encompass the plurality of trips, each of the plurality of trips providing detailed information about the vehicle movement within the geographical region. Further the system 102 may be configured to identify the specific link segment traversed by the plurality of trips. The system 102 may utilize techniques such as, but not limited to, the lane-level map matcher. The lane-level map matcher is an algorithm used in intelligent transportation systems to accurately align or match vehicle probe data with a specific link segment within a digital map. The link map matcher may determine, based on the trip data 116, the link segment on which the vehicle is traveling. In an example, the system 102 may receive the trip data 116 including 1000 trips taken by the plurality of vehicles. Further, the system 102 identifies the plurality of trips traversed on the first link segment 302A using the trip data 116. The system 102 is further configured to identify the plurality of trips traversed on the second link segment 302B, using the trip data 116. For example, the system 102 identifies 600 trips associated with the first link segment 302A, and 400 trips associated with the second link segment 302B.

Further the system 102 may be configured to identify the one or more trips from the plurality of trips associated with one or more lanes of the link segment. This process may involve lane-level map matching that precisely determines the lane in which the vehicle is traveling by analyzing the vehicle trajectory and matching the trip data 116 to detailed lane level digital map. By employing lane-level map matching, the system 102 may accurately distinguish each of the plurality of trips on each of the plurality of lanes in the link segment.

For instance, the system 102 may identify the lanes associated with the first link segment 302A, which include a first lane 304A, a second lane 304B, and a third lane 304C. Similarly, the system 102 identifies lanes associated with the second link segment 302B, which include, the first lane 304A, the second lane 304B, the third lane 304C, and a fourth lane 304D.

In an embodiment, further, the system 102 may be configured to identify the one or more trips from the plurality of trips traversed on the plurality of lanes. For instance, the system 102 may be configured to identify the one or more trips associated with the first lane 304A i.e., a first trip 306A, and a second trip 306B. The system 102 is further configured to identify one or more trips associated with the second lane 304B i.e., a third trip 306C. Further, the system 102 is configured to identify one or more trips associated with the third lane 304C i.e., a fourth trip 306D, and a fifth trip 306E.

Further, the system 102 is configured to determine the location data 110 associated with each of the plurality of trips. In an embodiment, the system 102 may determine the location data 110 for each trip traversed on each of the plurality of lanes. The location data 110 may include one or more origin location and one or more destination location. For example, the system 102 may determine each location data 110 associated with the first trip 306A, the second trip 306B, the third trip 306C, the fourth trip 306D, and the fifth trip 306E. In another example, the location data 110 may comprise a first origin location 308A, and a first destination location 310A associate with the first trip 306A. Similarly, the location data 110 may comprise a second origin location 308B and a second destination location 310B associated with the second trip 306B. Similarly, the location data 110 may comprise a third origin location 308C and a third destination location 310C associated with the third trip 306C. Similarly, the location data 110 may comprise a fourth origin location 308D and a fourth destination location 310D associated with the fourth trip 306D. Similarly, the location data 110 may comprise a fifth origin location 308E and a fifth destination location 310E associated with the fifth trip 306E.

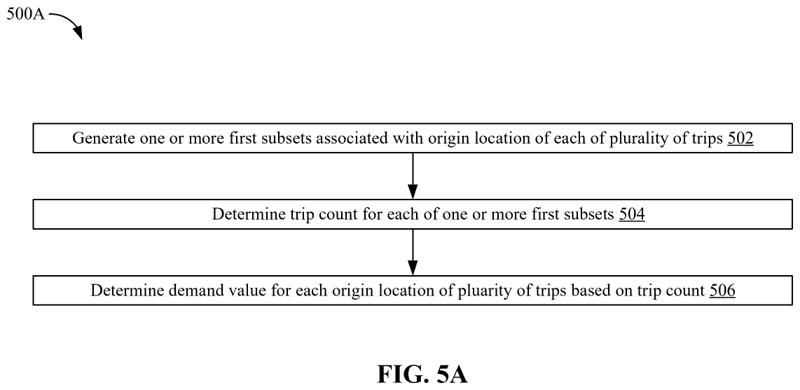

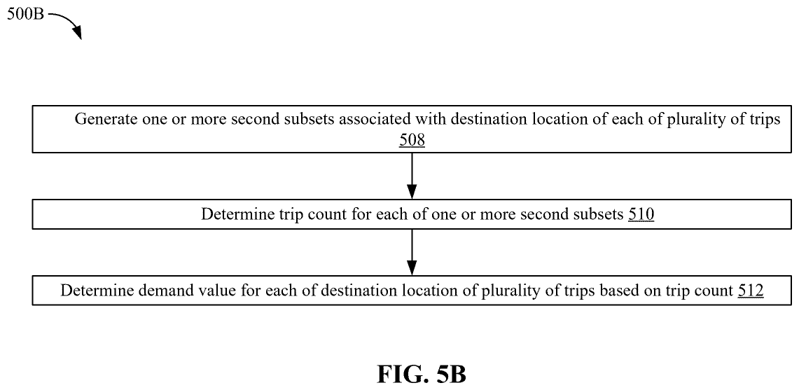

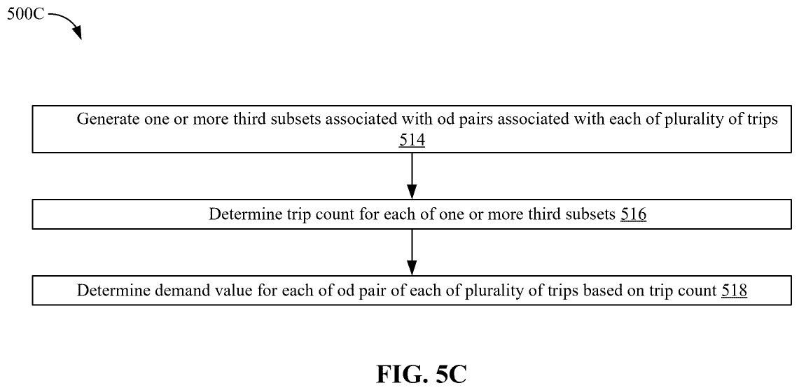

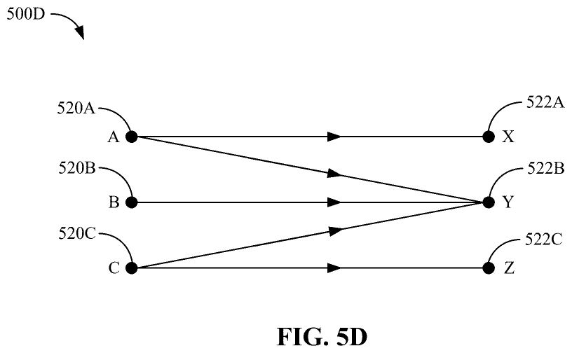

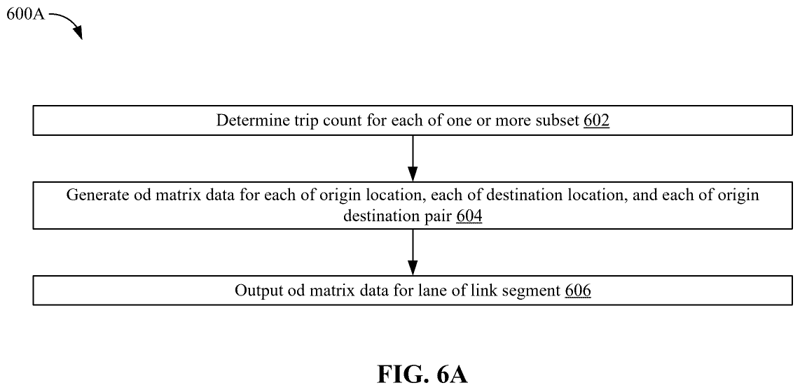

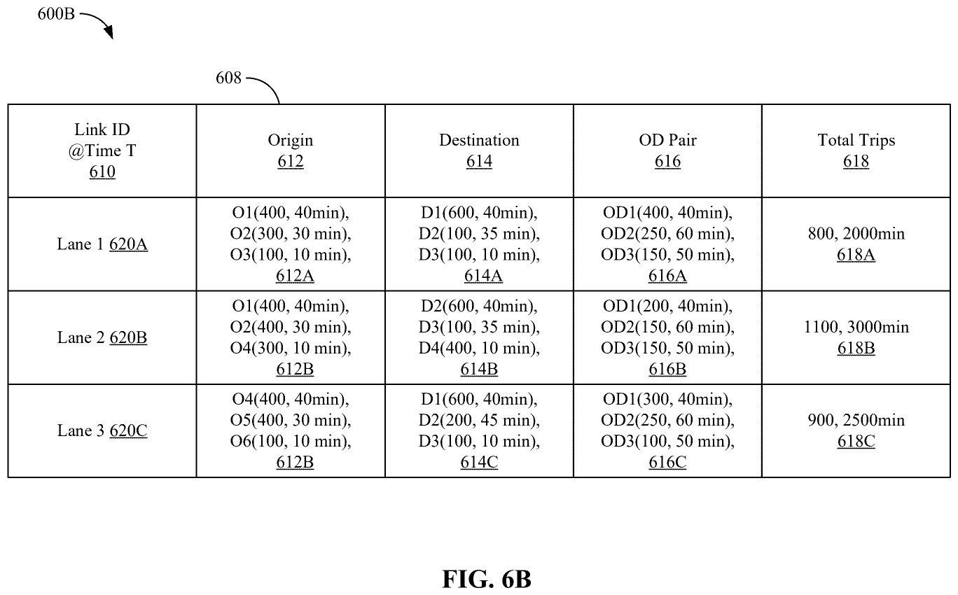

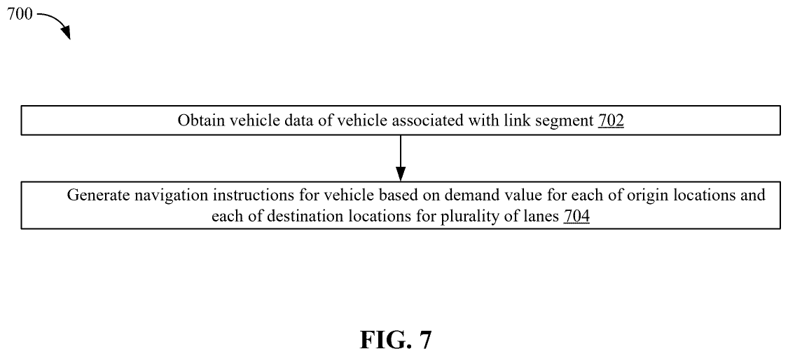

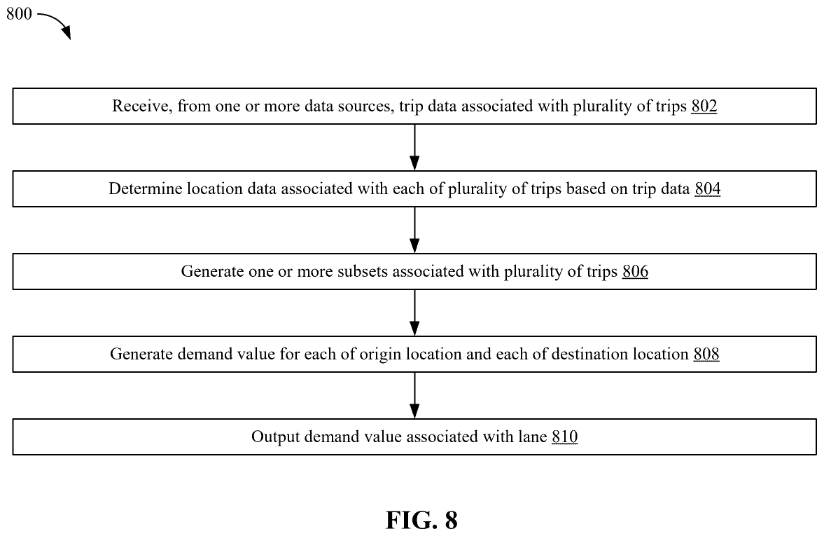

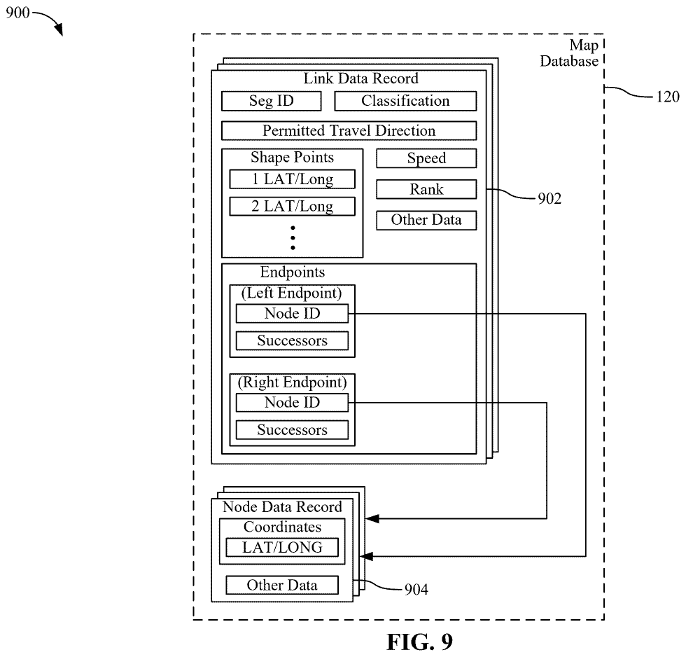

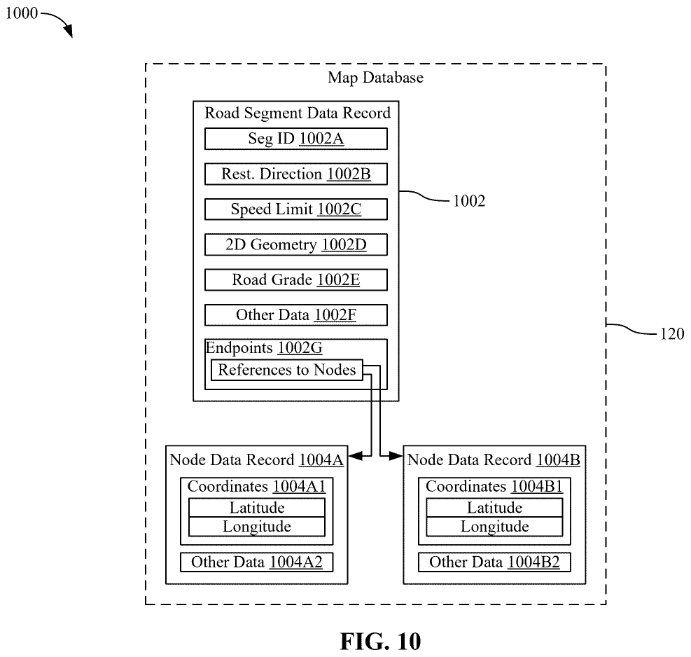

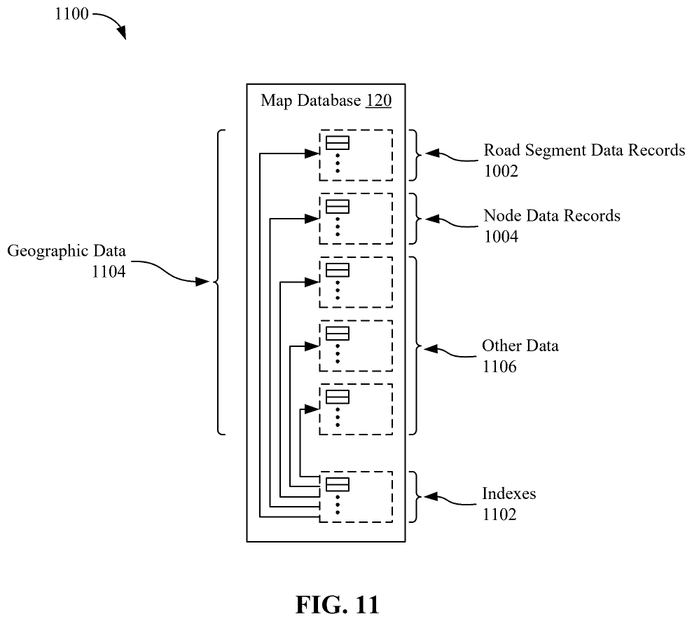

Further the system 102 is configured to generate the one or more subsets 112 associated with the plurality of trips which may be further described with conjunction of FIG. 4, FIG. 5A, FIG. 5B, FIG. 5C, FIG. 5D, FIG. 6A, FIG. 6B FIG. 7, FIG. 8, FIG. 9, FIG. 10, and FIG. 11

FIG. 4 illustrates a flowchart 400 that illustrates exemplary operations for determining one or more trips associated with the lane of a link segment, in accordance with an embodiment of the disclosure. FIG. 4 is explained in conjunction with elements from FIG. 1, FIG. 2, and FIG. 3. The exemplary method illustrated in the flowchart 400 may start at 402 and may be performed by any computing system, or device, such as by the system 102 of FIG. 1 or the processor 202 of FIG. 2. Although illustrated with discrete blocks, the exemplary method associated with one or more blocks of the flowchart 400 may be divided into additional blocks, combined into fewer blocks, or eliminated, depending on the particular implementation.

At 402, the system 102 may receive the trip data 116 associated with the plurality of trips. The trip data 116 may be associated with the link segment of the geographical region. In an example the trip data 116 may include plurality of trips associated with the one or more link segment of the geographical region. The trip data 116 may be received from the one or more sources such as, but not limited to, the database 106, or the vehicle communication system, which aggregate the data received from the one or more sensors associated with the vehicle and then send it the database. The data may be transmitted periodically or in real-time. For instance, the system 102 may receive the trip data 116 which may include thousand trips traversed in three link segments of the geographical region.

At 404, the system 102 may be configured to determine the plurality of trips associated with the one or more link segments of the geographical region. In an embodiment, the system 102 may determine the plurality of trips associated with the each of the link segments of the geographical region by utilizing various advanced techniques such as the link-map matcher. For instance, the system 102 receives data of 1000 trips associated with three link segments. Further the system 102 is configured to determine the number of trips associated with each of the three link segments. For instance, the system 102 may determine that 100 trips are associated with a first link segment, 400 trips are associated with a second link segment, and 500 trips are associated with a third link segment.

In an embodiment, the system 102 determines the trip associated with the link segment by using link map matcher. The link map matcher is an algorithm used in transportation and geographical information systems to align and match GPS trajectory data with specific segments of a digital road map. The process involves determining the most likely link segment or path that the vehicle has traversed based on its recorded GPS coordinates and trajectory data. The link map matcher works by preprocessing the GPS trajectory data to filter out any error or noise, ensuring that the data is clean and reliable. The link map matcher then identifies potential link segment that corresponds to each GPS point, searching within a defined radius to find possible matches. Each candidate link is evaluated based on factors such as its proximity to the GPS points, the direction of the link segment, and the vehicle's movement pattern. The algorithm scores these candidates and selects the sequence of the link segment that best fits the recorded trajectory. The output of this process is precisely matched path on the digital map that accurately represents the vehicle's journey. This high level of accuracy enhances various application such as navigation systems, by providing more precise routing and directions.

At 404, the system 102 may be configured to determine one or more trips associated with the lane of the link segment. In an embodiment, the system 102 may determine the one or more trips associated with the plurality of lanes of the link segment. In an example, after determining the plurality of trips associated with each of the link segment in the geographical region, further the system 102 calculates lane probabilities based on the distribution of trips across the lanes. Using these probabilities, the system 102 may identify the most likely lane for each of the plurality of trip, The system 102 further configured to determine one or more trips associated with each of the plurality of lanes of the link segment based on the lane probability. For instance, the system 102 may determine that there are 3 lanes in the first link segment and total 5 trips are traversed on a first lane of the first link segment, 20 trips are traversed on a second lane of the first link segment, and 75 trips are traversed on a third lane of the first link segment.

In another embodiment, the processor 202 may configured to identify the one or more trips from the plurality of trips associated with the lane using the lane-level map matcher model. In yet another embodiment, the lane level map matcher is applied to the trip data 116 associated with the plurality of trips traversed on the link segment the from each vehicle in order to obtain a series of the link segment and the lane that the vehicle/device traversed in sequence. In certain embodiments, the lane-level map matching may be performed by the vehicle where the lane identifier or information may be included with the trip data 116. Alternatively, the lane which the vehicle was traversing may be identified by the system 102 or the mapping platform 108 from information included with the trip data 116 of the vehicle. The lane-level map matcher may be run on each trajectory, or a vehicle path traveled in order to obtain the lane each vehicle traveled in along their route. This provides a path of the respective vehicles within the plurality of lanes along the link segment of the routes having the plurality of lanes. A distance metric may be used that separates each trajectory, where the distance metric is a function of lane center distances from a centerline of the link segment and may be a measure from the link segment centerline to the vehicle path, thus identifying the lane of the vehicle.

In an embodiment, the GPS data may be used by the system 102 to identify the link segment using the map matching algorithm to match the GPS coordinates to a stored map and the link segment. The lane-level map matching techniques may be used to identify the lane, for example, from the GPS data or additional sensor data included with the trip data 116. The trip data 116 may be collected at a high spatial resolution to distinguish between lanes of the link segment. As another example, the lane level map matcher may provide a good estimate of what lane the vehicle is on given a sequence of GPS probes coming from the trip data 116.

In an embodiment, sensor data such as lateral acceleration sensors may be used to identify the lane. The system 102 may detect lane changes by determining a threshold of acceleration X time, above which a lane change would have occurred. The system 102 may only detect that the change was of sufficient magnitude and direction to have a displacement greater than the lane width. Gyro compasses, gyro-like compasses or magnetometers of sufficient sensitivity may also be used to indicate if the vehicle is or is not turning onto another road. For example, a value would be less than a 45-degree total change without a road curvature. Another method may use lateral acceleration method indicating initiation of a lane change, followed by lateral deceleration without a large change in direction to indicate completion of the lateral displacement. A determination of intent or completion of the lane change may be determined using individual techniques or a combination of multiple techniques. The trip data 116 may include data from multiple sensor data from which the lane change maneuver may be derived. For the lane-level map matching, using historical raw GPS probe positions, a layer of abstraction may be created over a map which is used to generate lane probabilities of real-time probes based on their lateral position. In an embodiment, the probabilities form emissions probabilities of a hidden Markov model in which a Viterbi algorithm is used to make an inference of the actual most probable lane a probe trajectory traversed.

In another example, the lanes may be distinguished through another type of positioning. For example, the system 102 may analyze image data from a camera or distance data from a distancing system such as light detection and ranging (LiDAR). The system 102 may access a fingerprint or other template to compare with the image data or the distance data. Based on the comparison, the system 102 may determine the location of the vehicle, and based on the boundaries of the lanes, determines the lane of travel of the vehicle. In another example, the system 102 may detect lane lines. The lane lines may be detected from the camera data or distance data. Images of the road surface may be analyzed by the system 102 to identify patterns corresponding to lane lines that mark the edges of the lanes. Similarly, distance data such as LiDAR may include the location of lane markers.

The system 102 may select one or more trips traversed on at least a first lane on a first link segment during a first time period. The time period may be 1 min, 5 min, 10 min, 15 min, 60 min, and the like. In an embodiment, a day, week, month, or year may be divided into different time periods. For example, each hour of each day of the workweek may be set as a time period (for example, 4 pm Monday, Tuesday, Wednesday, Thursday, Friday). Holidays and other events may be separated out or measured in different buckets. As an example, if there is a unique event (e.g., sporting event) that affects traffic or is predicted to affect traffic, the trip data 116 for the time period when that event occurs may not be used during normal processing, but rather may be identified as a recurring event which is analyzed on its own or with other similar data. Similarly, weather data may be identified for a particular time period and separated or considered as weather may affect traffic patterns or traffic flows. For each time period there may be 10 s, 100 s, or thousands of trips that include the at least the first lane on the first link during the first time period.

In an embodiment, the system 102 is configured to receive map data indicating lane information associated with the link segment. In an embodiment, the system 102 is configured to receive map data indicating lane information associated with the link segment and identify the one or more trips from the plurality of trips associated with the lane of the link segment based on the trip data 116 and the map data, which includes specific information about the lanes associated with the link segment such as lane geometry, number of lanes, lane width, any special designation like bus or carpool lanes. For example, the process begins with the system 102 receiving comprehensive map data from the database 106 or mapping platform 108. The map data provides a granular view of the link segment, detailing each lane attributes. Once this map data is integrated, the system 102 processes the trip data 116, which comprises the GPS trajectories and time stamps of the each of plurality of lanes. For instance, if a vehicle's GPS data shows a trajectory that aligns closely with a specific lane's path on the map, the system 102 can match this trip to that particular lane.

In another embodiment, the one or more trips are associated with a predefined historical time period. Further, the system 102 is configured to determine a total trip count of the lane for the predefined historical time period based on the identified one or more trips. For instance, the system 102 determines the total trip time associated with each of the plurality of lanes for the historical time period. The trip count provides a quantitative measure of the lane's utilization and popularity among the user over a specified duration. It serves as a fundamental metric for transportation planners, urban developers, and policymakers to gauge the effectiveness of existing lane infrastructure and to make informed decisions regarding future expansion or modification.

Furthermore, the system 102 is configured to output the determined trip count for the lane. In an example, the processor 202 of the system 102 may configured to output the determined trip count for the each of the plurality of lanes associated with the link segment. For example, the output of the total trip count is valuable for various analytics purpose such as traffic flow analysis and congestion management. In an example, the system 102 may receive the trip data 116 comprising data associated with 1000 trips associated with 1-month period. In this example, the trip data 116 is associated with 3 lanes of a lane segment. Further the system 102 is configured to determine total trip count for each of the 3 lanes for the 1-month period. For instance, 200 trips are traversed on the first lane in past 1-month period, 300 trips are traversed on a second lane in past 1-month period, and 500 trips traversed on a third lane in past 1-month period. Further the system 102 is configured to output the total trip count for each of the 3 lanes.

In another embodiment, the one or more trips are associated with a predefined historical time period. Further the system 102 is configured to determine travel time data associated with each of the one or more trips based on the trip data 116. In an embodiment, the trip data 116 collected over a predefined historical time period are analyzed to derive valuable travel time insights for each of the plurality of lanes within the designated link segment of a geographical region. For instance, the system 102 receives trip data 116 from various sources, encompassing detailed information about the trip trajectories and associated metadata. Further, the system 102 accurately identifies trips that correspond to each individual lane within the link segment. Further the system 102 calculates travel time data associated with each trip based on the collected trip data 116. This involves analyzing factors such as starting and ending timestamps, routes complexity, any delays encountered during the journey. By aggregating and processing this information, the system 102 derives a comprehensive dataset of travel times for trips undertaken within the predefined historical period.

Further the system 102 is configured to determine average travel time for the lane during the predefined historical time period based on the determined travel time data. In an example, the system 102 computes the average travel time for the lane over the specified historical time period. The average travel time metrics provide a consolidated view of typical journey duration experienced by users using that particular lane. For instance, if the lane consistently recorded shorter average travel times compared to other lanes in same link segment, it may indicate smoother traffic flow or fewer congestion issues. Conversely, longer average travel times could highlight an area where improvement in traffic management or infrastructure might be beneficial.

Further the system may determine the demand value associated with the lane may further describe with conjunction of. FIG. 5A, FIG. 5B, FIG. 5C, FIG. 6, FIG. 7, FIG. 8, FIG. 9, FIG. 10, and FIG. 11

FIG. 5A illustrates a flowchart 500A that illustrates exemplary method for determining demand values 114 for origin location, in accordance with an embodiment of the disclosure. FIG. 5A is explained in conjunction with elements from FIG. 1, FIG. 2, FIG. 3, and FIG. 4. The exemplary method illustrated in the flowchart 500A may start at 502 and may be performed by any computing system, or device, such as by the system 102 of FIG. 1 or the processor 202 of FIG. 2. Although illustrated with discrete blocks, the exemplary method associated with one or more blocks of the flowchart 500A may be divided into additional blocks, combined into fewer blocks, or eliminated, depending on the particular implementation.

At 502, one or more first subsets associated with the origin location are generated. In an embodiment, the processor 202 is configured to generate the one or more first subsets 112 from the one or more subsets 112 which are associated with the origin location of each of the plurality of trips. Each of the one or more first subsets are associated with each origin location of each of the plurality of trips. In an example, the processor 202 identifies each of the plurality of trips that originate from each distinct origin location within the predefined dataset. For instance, consider a lane with several popular origin locations. The processor 202 may process the location data 110 which may include the starting point of each of the one or more trips from the plurality of trips traversed on the lane. The processor 202 is configured to identify these starting points and create subsets of trips that share the same origin location. Each of the one or more first subsets corresponds to a specific origin, aggregating all trips that begin from that location.

At 504, the trip count for each of the one or more first subsets are determined. In an embodiment, the processor 202 of system 102 is configured to determine a trip count for each of the one or more first subsets. In an embodiment, the processor 202 may determine trip count for each of the one or more first subsets associated with the lane of the link segment within the geographical region. In an example, the processor 202 may be configured to determine number the trips associated with the subset of the one or more first subsets originating from the origin location A. Further the processor 202 may configured to determine number of trips associated with the subset of the one or more first subsets originating from the origin location B. Further the processor 202 is configured to determine the number of trips associated with the subsets of the one or more first subsets originating at the originating from the origin location C. For instance, the processor 202 determines total number of trips originating from the origin location A may be 200, total number of trips originating from the origin location B may be 150, and total number of trips originating from the origin location C might be 100.

At 506, the demand value 114 for each origin location of plurality of trips based on trip count is determined. In an embodiment, the processor 202 of system 102 is configured to determine the demand value 114 for each of the origin location of the plurality of trips based on the trip count of the corresponding first subset from the one or more first subsets. The demand value 114 may correspond to the relative importance or usage frequency of each origin location in relation to the lanes of the link segment. For instance, based on the determined trip count for each of the one or more subset associated with each of the origin location of plurality of trips, the processor 202 may further configured to generate the demand value 114 for each of the origin location of the plurality of trips. For instance, the subset of the one or more first subsets originating from the origin location A may have a trip count of 200. The subset of the one or more first subsets originating from the origin location B may have trip count of 150. The subset of the one or more first subsets originating from the origin location C may have a trip count of 100. The demand value 114 of the origin location A will be highest and the demand value 114 of origin location B will be lower than the demand value 114 of origin location A, further the demand value 114 of origin location C will be less than the demand value 114 of origin location B. The demands value 114 may indicate how heavily each origin from one or more origin contributes to the traffic on the lane of the link segment. A higher the demand value 114 suggests a greater contribution to lane traffic.

FIG. 5B is a flowchart 500B that illustrates an exemplary method for determining demand values for destination location, in accordance with an embodiment of the disclosure. FIG. 5B is explained in conjunction with elements from FIG. 1, FIG. 2, FIG. 3, and FIG. 4. The exemplary operations illustrated in the flowchart 500B may start at 508 and may be performed by any computing system, or device, such as by the system 102 of FIG. 1 or the processor 202 of FIG. 2. Although illustrated with discrete blocks, the exemplary method associated with one or more blocks of the flowchart 500B may be divided into additional blocks, combined into fewer blocks, or eliminated, depending on the particular implementation.

At 508, one or more second subsets associated with the destination location of each of the plurality of trips is generated. In an embodiment, the processor 202 is configured to generate one or more second subsets from the one or more subset 112 which are associated with the destination location of each of the plurality of trips. Each of the one or more second subsets are associated with each of the destination location of each of the plurality of trips. In an example, the processor 202 may identify the one or more trips that concluding to each distinct destination location within the predefined dataset. For instance, consider a lane with several popular destination locations. The processor 202 processes the location data 110 which may include the destination point of each of the plurality of trips on the lane. The processor 202 is configured to identify each of the destination location of the one or more trips of the plurality of trips and may create subsets of each of the plurality of trips that share the same destination location. Each subset of the one or more second subsets correspond to a specific destination location, and the processor 202 configured to generate one or more second subsets associated with the plurality of trips that concluding at each of the destination location. For instance, the processor 202 identifies three destination location on the lanes of the link segment. Then the processor 202 examines the location data 110 and generate three distinct subsets of the one or more second subsets. A subset of one or more second subsets may include all the trips concluding a destination location A, a subset from one or more second subsets may include all the trips concluding at a destination location B, and a subset from the one or more second subsets may include all the trips concluding at a destination location C.

At 510, the trip count for each of one or more second subsets are determined. In an embodiment, the processor 202 of system 102 is configured to determine a trip count for each of the one or more second subsets. In an embodiment, the processor 202 may configured to determine the trip count for each of the one or more second subsets associated with the lane of the link segment. In an example, the processor 202 determine number the trip traversed in the first subset from the one or more second subsets concluding at the destination location A. for instance, the processor 202 may determine that total number of trips traversed to the destination location A may be 200. Further, the processor 202 may determine number the trips traversed in the subset from one or more second subsets concluding at the destination location B may be 150, Further, the processor 202 may determine total number the trips traversed in the subset from the one or more second subsets concluding at the destination location C may be 100.

At 512, the demand value 114 for each of the destination location of the plurality of trips based on trip are determined. In an embodiment, the processor 202 is configured to determine the demand value 114 for each of destination location of the plurality of trips based on the trip count of the corresponding second subset from the one or more second subsets. The demand value 114 represents the relative importance or usage frequency of each destination location in relation to the lanes of the link segment. For instance, based on the determined trip count for each of the one or more subset associated with each of the destination location of plurality of trips, the processor 202 may further configured to generate the demand value 114 for each of the destination location of the plurality of trips. For instance, a subset of one or more second subsets generated based on the same destination location the processor 202 further configured to determine total number of trips concluding at the destination location A is 200, total number of trips to the destination location B is 150, total number of trips to destination location C is 100. The determined demand value 114 of the destination location A will be highest and the determined demand value 114 of destination location B will be lower than the determined demand value 114 of destination location A, further the determined demand value 114 of destination location C will be less than the determined demand value 114 of destination location ‘B’. the determined demand value 114 may indicate how heavily each destination from one or more destination contributes to the traffic on the lane of the link segment. A higher the demand value 114 suggests a greater contribution to lane traffic.

FIG. 5C is a flowchart 500C that illustrates an exemplary method for determining demand values for OD pair, in accordance with an embodiment of the disclosure. FIG. 5C is explained in conjunction with elements from FIG. 1, FIG. 2, FIG. 3, FIG. 4, FIG. 5A, and FIG. 5B. The exemplary method illustrated in the flowchart 500C may start at 514 and may be performed by any computing system, or device, such as by the system 102 of FIG. 1 or the processor 202 of FIG. 2. Although illustrated with discrete blocks, the exemplary method associated with one or more blocks of the flowchart 500C may be divided into additional blocks, combined into fewer blocks, or eliminated, depending on the particular implementation.

At 514, one or more third subsets associated with one or more origin-destination OD pairs are generated. In an embodiment, the processor 202 is configured to generate one or more third subsets from the one or more subsets 112 which are associated with the one or more OD pairs. Each of the one or more third subsets are associated with the respective OD pairs from the one or more OD pairs. In an example, the processor 202 identifies all trips traversed on each distinct OD pair within the predefined dataset. For instance, consider a lane with several popular origin and destination pairs. The processor 202 processes the trip data 116 which may include the one or more origin locations and the one or more destination locations of each trip associated with the lane. The processor 202 is configured to identify an origin and a destination and create subsets of the one or more trips that share the same origin location and the same destination location. The third subset corresponds to a specific OD pair, aggregating all trips that begin from the same origin and end at the same destination. For instance, the processor 202 identifies three OD pairs on the lanes. Then the processor 202 examines the trip data 116 and generates three distinct subsets of the one or more third subsets.

At 510, the trip count for each of one or more third subsets are determined. In an embodiment, the processor 202 of system 102 is configured to determine the trip count for each of the one or more third subsets. In an embodiment, the processor 202 may determine the trip count for each of the one or more third subsets associated with the lane of the link segment. In an example, the processor 202 may determine total number of the trip traversed in the first subset from one or more third subsets starting at the origin location ‘A’ and ending on the destination location ‘X’. For instance, the total number of trips traversed on the first OD pairs might be 200. Further, the processor 202 determine number the trip traversed in the second subset from one or more third subsets starting at the origin location ‘B’ and ending on the destination location ‘Y’. For instance, the total number of trips traversed to the second OD pairs might be 150. Further, the processor 202 determine total number the trip traversed in the third subset from one or more third subsets starting at an origin location ‘C’ and ending on a destination location ‘Z’. For instance, the total number of trips traversed to the third OD pairs ‘C’ might be 100.

At 512, the demand value 114 for each of one or more OD pairs based on the trip count of corresponding third subset from one or more third subsets are determined. In an embodiment, the processor 202 of system 102 is configured to determine the demand value 114 for each of the one or more OD pairs based on the trip count of the corresponding to first subset of the one or more third subsets. The demand value 114 represents the relative importance or usage frequency of each OD pairs in relation to the lanes of the link segment. For instance, the processor 202 may have previously identified and counted trips within each of the one or more third subsets based on the origin and the destination, the processor 202 may configured to generate the demand value 114. For instance, in first subset of one or more third subsets, the total number of trips to first OD pairs is 200, total number of trips to second OD pairs ‘C’ is 150, total number of trips to third OD pairs is 100. The demand value 114 of the first OD pairs will be highest and the demand value 114 of the second OD pairs will be lower than the demand value 114 of the first OD pairs, further the demand value 114 of the third OD pairs will be less than the demand value 114 of the second OD pairs ‘B’. the demand value 114 may indicate how heavily each destination from one or more destination contributes to the traffic on the lane of the link segment. A higher the demand value 114 suggests a greater contribution to lane traffic.

FIG. 5D illustrates a diagram that shows plurality of trips between origin and destination, in accordance with an embodiment of the disclosure. FIG. 5D is explained in conjunction with elements from FIG. 1, FIG. 2, FIG. 3, FIG. 4 FIG. 5A, FIG. 5B, and FIG. 5C With reference to FIG. 5D, there is shown a diagram 500D that illustrates one or more origin locations and one or more destination locations.

In embodiment, the trip data 116 may include a plurality of trips associated with a specific link segment 520. For instance, the trip data 116 may include the plurality of trips for the link segment 520. Each of the plurality of trips provides valuable information about vehicle movements and traffic patterns along the link segment 520.

In another embodiment, the processor 202 identifies three distinct origin locations associated with the plurality of trips based on the location data 110. For instance, the processor 202 determines that the one or more trips originate from an origin location A 520A, an origin location B 520B, and an origin location C 520C. Upon identifying the origin locations, the processor 202 examines the location data 110 more closely and generates three subsets from the one or more first subsets. One subset includes all the trips originating from the origin location A 520A, while the second subset includes all the trips originating from the origin location B 520B, and the third subset includes all the trips originating from the origin location C.

Furthermore, the system 102 generates the demand value 114 for each origin location associated with the plurality of trips. For example, the demand value 114 for the origin location A 520A is determined to be 100, indicating 100 trips originating from the origin location A520A. In contrast, the demand value 114 for origin location B 520B is determined to be 200, and the demand value 114 for the origin location C 520C is determined to be 300, reflecting a higher level of activity with higher numbers of trips originating from that location C 520C. These demand values 114 provide critical insights into traffic patterns, helping to identify which origin locations are more heavily trafficked and informing transportation planning and management strategies.

In another embodiment, the processor 202 may identify three distinct destination locations associated with the plurality of trips based on the location data 110. For instance, the processor 202 may determine that one or more trips are concluding at a destination location X 522A, a destination location Y 522B, and a destination location Z 522C. Upon identifying the destination locations, the processor 202 examines the location data 110 more closely and generates three subsets from the one or more second subsets. A first subset includes all the trips concluding at the destination location X 522A, a second subset includes all the trips concluding at the destination location Y 522B, and a third subset includes all the trips concluding at the destination location Z 522C.

Furthermore, the system 102 may generate the demand value 114 for each destination location associated with the plurality of trips. For example, the demand value 114 for the destination location X 522A is determined to be 150, indicating 150 trips concluding at that location. In contrast, the demand value 114 for the destination location Y 522B is determined to be 150, and the demand value 114 for the destination location Y 522B is determined to be 300,

In another embodiment, the processor 202 may identify five distinct OD pairs associated with the plurality of trips based on the location data 110. For instance, the processor 202 may recognizes a first OD pair include the one or more trips having the origin location A 520A and the destination location X 522A, a second OD pair include the one or more trips having a origin location B 520B and the destination location Y 522B, a third OD pair include the one or more trips having the origin location C 520C and the destination location Z 522C, a fourth OD pair include the one or more trips having the origin location A 520A and the destination location Y 522B, and a fifth OD pair includes one or more trips having the origin location C 520C and the destination location Y 522B. Upon identifying the OD pairs, the processor 202 examines the location data 110 more closely and generates five subsets from the one or more third subsets. A first subset includes the one or more trips in the first OD pair, a second subset includes the one or more trips in the second OD pair, a third subset includes the one or more trips in the third OD pair, a fourth subset includes the one or more trips in the fourth OD pair, a fifth subset includes the one or more trips in the fifth OD pair.

Furthermore, the system 102 may determine the demand value 114 for each of the OD pair of each of the plurality of trips based on the trip count of the corresponding subset from the one or more third subsets. For example, the demand value 114 for the trips originating at the origin location A 520A and concluding at the destination location X 522A is determined to be 100. In contrast, the demand value 114 for the one or more trips originating at the origin location B 520B and concluding at the destination location Y 522B is determined to be 200, the demand value 114 for the one or more trips originating at the origin location C 520C and concluding at the destination location Z 522C is determined to be 200. The demand value 114 for the one or more trips originating at the origin location A 520A and concluding at the destination location Y 522B is determined to be 100, and the demand value 114 for the one or more trips originating at the origin location C 520C and concluding at the destination location Y 522B is determined to be 50 reflecting a lower level of activity with only 50 trips traversed between the locations.

FIG. 6A is a flowchart 600A that illustrates an exemplary method for determining demand values for OD pair, in accordance with an embodiment of the disclosure. FIG. 6A is explained in conjunction with elements from FIG. 1, FIG. 2, FIG. 3, FIG. 4, FIG. 5A, FIG. 5B, FIG. 5C and FIG. 5D. The exemplary method illustrated in the flowchart 600A may start at 602 and may be performed by any computing system, or device, such as by the system 102 of FIG. 1 or the processor 202 of FIG. 2. Although illustrated with discrete blocks, the exemplary method associated with one or more blocks of the flowchart 600 may be divided into additional blocks, combined into fewer blocks, or eliminated, depending on the particular implementation.

At 602, the trip count for each of the one or more subsets 112 is determined. In an embodiment, the processor 202 may be configured to determine the trip count for each of the one or more subsets 112 based on the number of one or more trips associated with each of the one or more subsets 112. In an embodiment, the processor 202 may be configured to determine the trip count for each of the one or more first subsets from one or more subsets 112 having same origin location, further the processor 202 may configured to determine the trip count for each of the one or more second subsets from one or more subsets 112 having same destination location, and further the processor 202 may configures to determine the trip count for the one or more third subsets from the one or more subsets 112 having same origin location and same destination location.

In another embodiment, the processor 202 is configured to determine the OD pair from the plurality of trips based on the location data 110. In an example, the processor 202 may determine the location data 110 including GPS coordinates marking each of the origin location and each of the destination location of the vehicle traversing on the lane of the link segment. Then the processor 202 may utilize the location data 110 to determine the OD pairs for each of the plurality of trips on each lane. For instance, the processor 202 may determine the OD pair from the one or more OD pairs which include the one or more trips originating from an origin location A and concluding at a destination location X, further the processor 202 may determine another OD pair from the one or more OD pairs including the one or more trips originating at an origin location B and concluding at a destination location Y.

Further the processor 202 is configured to generate the one or more subsets 112 of the one or more trips based on each of the OD pairs associated with each of the plurality of trips. This involves categorizing the one or more trips into distinct groups or subsets according to their OD pairs, enabling detailed analysis of traffic patterns and demands for that particular lane. For instance, consider a lane of a link segment, the processor 202 may determine each of the OD pairs associated with the plurality of trips for that lane. For instance, an OD pair includes the one or more trips from the origin A to the destination X, and the origin B to destination Y. The processor 202 may generate one or more subsets 112 of the one or more trips, where each of the one or more subsets 112 correspond to each of the OD pair. For example, first subset might correspond to the one or more trips from the origin A to destination X. are predominantly made during morning peak hours, indicating a commuter flow from the origin A to the destination B. the second subset could show a higher volume of trips suggesting the change in traffic pattern.

At 604, OD matrix data for each of origin location, each of destination location, each of origin destination pair is generated. In an embodiment, the processor 202 is configured to generate OD matrix data for each of the origin location of each of the plurality of trips and each of the destination location of each of the plurality of trips, based on the trip count for each of the one or more subsets112. In an example, the processor 202 is configured to generate the OD matrix data for each of the origin location of the plurality of trips, each of the destination location of the plurality of trips, and each of the OD pair of the plurality of trips. In an example, in the OD matrix data, a greater demand value 114 for an origin location represents a higher traffic flow from that particular origin location. In an embodiment, in the OD matrix, a greater demand value 114 for a destination represents a higher number of trips terminating at that particular destination location. In another embodiment, in the OD matrix, a greater demand value 114 for an OD pair represents a higher number of trips flowing from a particular origin and ending at a particular destination location.

At 606, the OD matrix data for the lane of the link segment are output. In an example, the processor 202 may be configured to output the OD matrix data for the lane of the link segment. In an example, the processor 202 is configured to output the at least one of: the one or more origin locations, or the one or more destination locations for the lane in association with the trip count of a corresponding subset from the one or more subsets 112. The system 102 may highlight the most frequently used routes, origin, and destination. Thereby offering valuable data for traffic management and urban planning.

In another embodiment, the processor 202 may be configured to rank at least one of: each of the origin location of each of the plurality of trips, each of the destination location of each of the plurality of trips, or each of the OD pairs based on the demand value 114. In an example, by analyzing historical trip data, user preferences, and real-time factors such as traffic conditions or events, the processor 202 may assign a quantitative demand value 114 to each location. The ranking process can be broken down into three key components: origin locations, destination locations, and OD pairs. Each of the origin location of the plurality of trips is evaluated to determine which origin location generates the highest demand for travel, which may help identify each of popular origin locations of the plurality areas for potential service expansion or targeted marketing. Each of the destination locations are ranked to highlight where travelers are most frequently heading, guiding resource allocation, such as where to position vehicles or services. Further, the processor 202 is configured to rank the OD pairs, providing insights into the most traveled routes, which may inform infrastructure development, traffic management strategies, and service offerings.

Further the processor 202 is configured to generate one or more sets of ranked results based on the ranking, wherein each of the one or more sets of ranked results comprises a corresponding sequence associated with at least one of: origin location, destination location, or OD pairs. In an example, the processor 202 is configured to generate one or more sets of ranked results based on the previously established ranking of trip locations. Each set of ranked results comprises a corresponding sequence that is associated with at least one of the following: origin locations, destination locations, or origin-destination (OD) pairs. This functionality is crucial for optimizing travel routes and enhancing user experience in transportation systems. To achieve this, the processor 202 analyses the demand value 114 assigned to each origin location of the plurality of trips, each destination location of the plurality of trips and each of the OD pair of the plurality of trips, creating a comprehensive view of travel patterns. For instance, when generating a set of ranked results for origin locations, the processor 202 identifies which starting points exhibit the highest demand for trips. This information may be particularly valuable for transportation companies looking to allocate resources effectively, ensuring that vehicles are positioned in areas where they are most likely to be needed. Similarly, the processor 202 generates a ranked sequence that highlights the most popular endpoints for travellers. Further the processor 202 is configured to generate one or more sets of ranked results based on the previously established ranking of trip location results of the most popular OD pair of the plurality of trips.

FIG. 6B is a block diagram 600B that illustrates schematic diagram of OD matrix data, in accordance with an embodiment of the disclosure. FIG. 6B is explained in conjunction with elements from FIG. 1, FIG. 2, FIG. 3, FIG. 4, FIG. 5A, FIG. 5B, FIG. 5C, FIG. 5D and FIG. 6A. Although illustrated with discrete blocks, the exemplary schematic diagram associated with one or more blocks of the block diagram 600B may be divided into additional blocks, combined into fewer blocks, or eliminated, depending on the particular implementation.

In an embodiment, a table 608 includes exemplary OD matrix data. This OD matrix data may include a LINK ID 610 that corresponds to a specific link segment. The LINK ID 610 can be associated with a particular time, such as Monday at 2 PM, providing a temporal context for the traffic analysis. Additionally, the OD matrix data encompasses location data 110, which includes several key components: an origin 612, a destination 614, an OD pair 616, and total trips 618. The origin 612 represents the determined origin location associated with each of the plurality of trips, allowing for the identification of where trips begin. The destination 614 indicates the determined destination location associated with each of the plurality of trips, highlighting where trips conclude. The OD pair 616 consists of one or more trips from the plurality of trips that share the same origin and destination locations. This information is essential for understanding travel patterns between specific points in the network. Furthermore, the total trips 618 reflect the overall number of trips associated with each lane, providing a comprehensive view of traffic volume.

By organizing the OD matrix data in this manner, the system 102 may effectively analyze traffic flow, identify trends, and make informed decisions regarding transportation planning and management. This structured approach facilitates the identification of high-demand routes, enabling authorities to optimize traffic operations and improve overall mobility within the geographical area.

In an example, as illustrated in the table 608, the link segment with the LINK ID 610 comprises three lanes: a lane 1 620A, a lane 2 620B, and a lane 3 620C. At 612A, the one or more origins associated with lane 1 are detailed. For instance, origin location O1 is the first origin associated with lane 1 620A, and the OD matrix data indicates that the number of trips originating from O1 is 400. Additionally, the OD matrix data includes the average travel time from origin location O1, which is 40 minutes. Similarly, for origin location O2, the total number of trips originating is 300, with an average travel time of 30 minutes. For origin location O3, the total trip count is 100, and the average travel time is 10 minutes.

At 614A, the OD matrix data includes the one or more destination locations associated with lane 1 620A. For instance, destination location D1 has a total trip count of 600 and an average travel time of 40 minutes. Similarly, for destination location D2, the total trip count is 100 with an average travel time of 35 minutes. Additionally, destination location D3 has a total trip count of 100 and an average travel time of 10 minutes.

At 616A, the OD matrix data includes one or more OD pairs associated with lane 1 620A. For example, the first OD pair, OD1, has a total trip count of 400 and an average travel time of 40 minutes. Similarly, the second OD pair, OD2, shows a total of 250 trips with an average travel time of 60 minutes. Additionally, the third OD pair, OD3, has a total trip count of 150 and an average travel time of 50 minutes. At 618A, the OD matrix data may include the total trip count and total time taken on lane 1 620A. For instance, the total trip count associated with lane 1 is 800, while the total duration of travel on this lane is 2,000 minutes.

In an example, the OD matrix data encompasses the location data 110, which may include: an origin 612B, a destination 614B, an OD pair 616B, and total trips 618B. Similarly, the OD matrix data may include the location data 110, which may include an origin 612C, a destination 614C, an OD pair 616C, and total trips 618C.

In an exemplary embodiment, the origin location a may be stored using the map or hash-table data structure where the origin O is used as a key and a value is the trip count. Similarly, the destination location may be stored using the map or hash-table data structure where the destination D is used as the key and the value is the trip count. Similarly, the OD pair may be stored using map or hash-table data structure, where the OD pair is the key, and the value is trip count. This approach allows for efficient retrieval and management of trip data 116, enabling quick access to the number of trips originating from each location. By utilizing the map or hash-table, the system 102 may effectively organize and analyze location data 110, facilitating better insights into traffic patterns and supporting informed decision-making for transportation planning and management

In another exemplary embodiment, the od matrix data may display top K popular origin location, destination location, and the OD pairs. This feature allows transportation planners and traffic management authorities to quickly identify the most heavily trafficked areas and routes within the network. By focusing on the top K results, stakeholders may prioritize their efforts and resources to address the most significant traffic-related challenges. The display of popular origin-destination pairs is particularly useful for understanding travel patterns and optimizing route guidance. This targeted approach to data presentation enhances the overall efficiency and effectiveness of transportation planning and management strategies.

FIG. 7 illustrates a flowchart 700 that illustrates an exemplary method for generating navigation instructions for vehicles, in accordance with an embodiment of the disclosure. FIG. 7 is explained in conjunction with elements from FIG. 1, FIG. 2, FIG. 3, FIG. 4, FIG. 5A, FIG. 5B, FIG. 5C, FIG. 5D, FIG. 6A and FIG. 6B. The exemplary method illustrated in the flowchart 700 may start at 702 and may be performed by any computing system, or device, such as by the system 102 of FIG. 1 or the processor 202 of FIG. 2. Although illustrated with discrete blocks, the exemplary method associated with one or more blocks of the flowchart 700 may be divided into additional blocks, combined into fewer blocks, or eliminated, depending on the particular implementation.

At 702, vehicle data of the vehicle associated with link segment is obtained. In an embodiment, the processor 202 of the system 102 may be configured to obtain vehicle data of a vehicle associated with link segment. In an embodiment, the processor 202 may continuously receive vehicle data of the vehicle associated with each of the plurality of lanes associated with the link segment. The vehicle data may include such as, but not limited to geospatial coordinates (latitude and longitude) of each vehicle, speed, acceleration, direction of movement, timestamps to correlate position with the specified times, and vehicle characteristics such as, vehicle type and size and dimensions and vehicle status for any alerts that might influence route choice.

At 704, navigation instruction for the vehicle is generated. In an embodiment, the processor 202 of the system 102 may be configured to generate navigation instructions for the vehicle based on the demand value for each of the origin location of the plurality of trips and each of the destination location of the plurality of trips associated with each of the plurality of lanes. For example, utilizing the previously calculated demand values, which indicate traffic density and flow pattern, the system 102 dynamically generates optimized navigation instructions. This involves selecting a lane from one or more lanes associated with the link segment that minimizes travel time and avoid congestion by considering real-time traffic conditions, historical traffic pattern associated with the link and predictive analytics. For example, the navigation instruction is tailored to the specific vehicle, considering its current location, destination and unique requirement, ensuring the route aligns with operational parameter and driver preference. The processor 202 continuously monitors the vehicle's progress and traffic conditions, updating the navigation instruction as necessary. For example, if the vehicle is traversing on a road and the vehicle have to take turn from the corresponding road, then the system 102 may provide the navigation instruction to traverse on a lane from which taking turn may not affect the traffic behind the vehicle. If a delivery truck is navigating through a busy urban area, the system 102 uses real-time GPS data and speed to detect high traffic on the one lane and generate an alternate lane through less congested, ensuring timely delivery and avoiding delays. In another example, if any accident occurs on a lane of a link segment, which may affect the traffic flow on the corresponding lane and adjacent lane, then the system 102 may provide alert to the user regarding the same.

FIG. 8 illustrates a flowchart 800 that illustrates an exemplary method for generating demand value 114 associated with lane, in accordance with an embodiment of the present disclosure. FIG. 8 is explained in conjunction with elements from FIG. 1, FIG. 2, FIG. 3, FIG. 4, FIG. 5A, FIG. 5B, FIG. 5C, FIG. 5D, FIG. 6A, FIG. 6B and FIG. 7. The operations of the exemplary method may be executed by any computing system, for example, by the system 102 of FIG. 1 or the processor 202 of FIG. 2. The operations of the flowchart 800 may start at 802.

At 802, the trip data 116 associated with plurality of trips is received from the one or more data sources. In an embodiment, the system 102 may be configured to receive, from the one or more data sources, the trip data 116 associated with the plurality of trips. Each of the plurality of trips is associated with the lane of the link segment within the geographical region. In at least one embodiment, the processor 202 may be configured to receive the trip data 116 associated with the plurality of trips, as described, for example, in FIG. 4.

At 804, the location data 110 associated with each of the plurality of trips based on the trip data are determined. In an embodiment, the system 102 may be configured to determine location data 110 associated with each of the plurality of trips based on the trip data 116. The location data 110 comprises the origin location and the destination location. In at least one embodiment, the processor 202 may be configured to determine the location data 110 associated with the each of the plurality of trips based on the trip data 116, as described, for example, with reference to FIG. 4.

At 806, one or more subsets associated with the plurality of trips are generated. In an embodiment, the system 102 may be configured to generate the one or more subsets 112 associated with the plurality of trips. Each of the one or more subsets 112 is associated with at least one of: an origin location from the origin location of each of the plurality of trips, a destination location from the destination location of each of the plurality of trips, or a combination thereof. Each of the one or more subsets comprises one or more trips from the plurality of trips. In at least one embodiment, the processor 202 may be configured to generate one or more subsets 112 associated with the plurality of trips, as described, for example, with reference to FIG. 5A, FIG. 5B, and FIG. 5C.

At 808, the demand value 114 for each of the origin location and each of the destination location is generated. In an embodiment, the system 102 may be configured to generate the demand value 114 for each of the origin location of each of the plurality of trips and each of the destination location of each of the plurality of trips based on the one or more subsets. In at least one embodiment, the processor 202 may be configured to generate a demand value 114 for each of the origin location and each of the destination location based on the one or more subsets 112, as described, for example, with reference to FIG. 5A, FIG. 5B, and FIG. 5C.

At 810, the demand value 114 associated with the lane is output. The system 102 may be configured to output the demand value 114 associated with the lane. In at least one embodiment, the processor 202 may be configured to output the demand value 114 associated with the lane, as described, for example, with reference to FIG. 6.

Accordingly, blocks of the flowcharts 400, 500A, 500B, 500C, 600, 700, and 800 support combinations of means for performing the specified functions and combinations of operations for performing the specified functions. It will also be understood that one or more blocks of the flowcharts 400, 500A, 500B, 500C, 600, 700, and 800 combinations of blocks in the flowcharts 400, 500A, 500B, 500C, 600, 700, and 800 can be implemented by special purpose hardware-based computer system which perform the specified functions, or combinations of special purpose hardware and computer instructions.

Alternatively, the system 102 may comprise means for performing each of the operations described above. In this regard, according to an example embodiment, examples of means for performing operations may comprise, for example, the processor 202 and/or a device or circuit for executing instructions or executing an algorithm for processing information as described above.

On implementing the flowcharts 400, 500A, 500B, 500C, 600, 700, and 800 disclosed herein, the end result generated by the system 102 is a tangible navigation recommendation based on demand value associated with each of the lanes.

Returning to FIG. 1, the communication network 104 may be wired, wireless, or any combination of wired and wireless communication networks, such as cellular, Wi-Fi, internet, local area networks, or the like. In some embodiments, the communication network 104 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, international telecommunication union (ITU) -international mobile communications (IMT) 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In another embodiment, the system 102 may be embodied as a cloud-based service, a cloud-based application, a cloud-based platform, a remote server-based service, a remote server-based application, a remote server-based platform, or a virtual computing system. In yet another example embodiment, the system 102 may be an OEM (Original Equipment Manufacturer) cloud. The OEM cloud may be configured to anonymize any data received by the system 102, such as from a set of road attributes, before using the data for further processing, such as before sending the data to the map database 120. For an example, anonymization of the data may be done by the mapping platform 108.

The mapping platform 108 may comprise suitable logic, circuitry, and interfaces that may be configured to store one or more map attributes and sensor data associated with traffic on link segments. The mapping platform 108 may be configured to store and update map data indicating the traffic data along with other map attributes, road attributes, and traffic entities, in the map database 120. The mapping platform 108 may include techniques related to, but not limited to, geocoding, routing (multimodal, intermodal, and unimodal), clustering algorithms, and machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may comprise one or more physical packages (such as chips) that include materials, components, and/or wires on a structural assembly (such as a baseboard).

In some example embodiments, the mapping platform 108 may include the processing server 118 for carrying out the processing functions associated with the mapping platform 108 and the map database 120 for storing map data. In an embodiment, the processing server 118 may include one or more processors configured to process requests received from the system 102. The processors may fetch sensor data and/or map data from the map database 120 and transmit the same to the system 102 in a format suitable for use by the system 102.

Continuing further, the map database 120 may comprise suitable logic, circuitry, and interfaces that may be configured to store the sensor data and map data, which may be collected from the at least one image capture sensor and/or the vehicle. In an embodiment, the vehicle may be traveling on a first lane segment of the road segment, or in a region close to the first lane segment. In accordance with an embodiment, such sensor data may be updated in real-time or near real-time such as within a few seconds, a few minutes, or on an hourly basis, to provide accurate and up-to-date sensor data. The sensor data may be collected from any sensor that may inform the mapping platform 108 or the map database 120 of features within the geographical region that are appropriate for traffic-related services. In accordance with an embodiment, the sensor data may be collected from any sensor that may inform the mapping platform 108 or the map database 120 of features within the geographical region that are appropriate for mapping. For example, motion sensors, inertia sensors, image capture sensors, proximity sensors, LiDAR sensors, and ultrasonic sensors may be used to collect the sensor data. The gathering of massive quantities of crowd-sourced data may facilitate the accurate modeling and mapping of an environment, whether it is a road link or a link within a structure, such as in an interior of a multi-level parking structure.

The map database 120 may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the map database 120 may be configured to receive the map data including the road topology and geometry-related attributes related to the road network from external systems, such as one or more of background batch data services, streaming data services, and third-party service providers, via the communication network 104.

In accordance with an embodiment, the map data stored in the map database 120 may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 120 may further store historical probe data for events (such as, but not limited to, traffic incidents, construction activities, scheduled events, and unscheduled events) associated with Point of Interest (POI) data records or other records of the map database 120.

For example, the data stored in the map database 120 may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received map database 120 in a delivery format to produce one or more compiled navigation databases.

In some embodiments, the map database 120 may be a master geographic database configured on the side of the system 102. In accordance with an embodiment, the map database 120 may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-user vehicles (such as the vehicle) which use vehicles on-board one or more sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the map database 120.

For an example, the map database 120 may include lane and intersection data records or other data that may represent links in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations or charging stations. The map database 120 may additionally include data about places, such as cities, towns, or other communities, and other geographic features such as, but not limited to, bodies of water, and mountain ranges.

In some example embodiments, images received from the image source, for example, the at least one image capture sensor may be stored within the map database 120 of the mapping platform 108. In certain cases, the mapping platform 108, using the processing server 118, may suitably process the received images. For example, such processing may include, suitably labeling the images based on corresponding associated lane and/or link, point of interest within the link and/or lane, and other information relating to the respective link and/or lane. Such labeled images may then be stored within the map database 120 as map data.

FIG. 9 shows format of the map data 900 stored in the map database 120 according to one or more example embodiments. FIG. 9 shows a link data record 902 that may be used to store data about one or more of the feature lines. This link data record 902 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 902 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 108 and its associated map database developer selects one or more shape points along the other-than-straight road portion. Shape point data included in the link data record 902 indicate the position, (e.g., latitude, longitude, and optionally, altitude or elevation) of the selected shape points along the represented link.

Additionally, in the compiled geographic database, such as a copy of the map database 120, there may also be a node data record 904 for each node. The node data record 904 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 10 shows another format of the map data 1000 stored in the map database 120 according to one or more example embodiments. In the FIG. 10, the map data 1000 is stored by specifying a road segment data record 1002. The road segment data record 1002 is configured to represent data that represents a road network. In FIG. 2C, the map database 120 contains at least one road segment data record 1002 (also referred to as “entity” or “entry”) for each road segment in a geographic region.

The map database 120 that represents the geographic region of FIG. 2 also includes a node data record 1004 (a node data record 1004A and a node data record 1004B) (or “entity” or “entry”) for each node associated with the at least one road segment shown by the road segment data record 1002. (The terms “nodes” and “segments” represent only one terminology for describing these physical geographic features and other terminology for describing these features is intended to be encompassed within the scope of these concepts). Each of the node data records 1004A and 1004B may have associated information (such as “attributes”, “fields”, etc.) that allows identification of the road segment(s) that connect to it and/or its geographic position (e.g., its latitude and longitude coordinates).

FIG. 10 shows some of the components of the road segment data record 1002 contained in the map database 120. The road segment data record 1002 includes a segment ID 1002A by which the data record can be identified in the map database 120. Each road segment data record 1002 has associated with it information (such as “attributes”, “fields”, etc.) that describes features of the represented road segment. The road segment data record 1002 may include data 1002B that indicate the restrictions, if any, on the direction of vehicular travel permitted on the represented road segment. The road segment data record 1002 includes data 1002C that indicates a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 1002 may also include data 1002D indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 1002 also includes road grade data 1002E that indicates the grade or slope of the road segment. In one embodiment, the road grade data 1002E includes road grade change points and a corresponding percentage of grade change. Additionally, the road grade data 1002E may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 1002E includes the road grade change points and an actual road grade value for the portion of the road segment after the road grade change point until the next road grade change point or end node. In a further embodiment, the road grade data 1002E includes elevation data at the road grade change points and nodes. In an alternative embodiment, the road grade data 1002E is an elevation model which may be used to determine the slope of the road segment.

The road segment data record 1002 also includes data 1002G providing the geographic coordinates (e.g., the latitude and longitude) of the end points of the represented road segment. In one embodiment, the data 1002G are references to the node data records 1002 that represent the nodes corresponding to the end points of the represented road segment.

The road segment data record 1002 may also include or be associated with other data 1002F that refer to various other attributes of the represented road segment. The various attributes associated with a road segment may be included in a single road segment record or may be included in more than one type of record which cross-reference each other. For example, the road segment data record 1002 may include data identifying the name or names by which the represented road segment is known, the street address ranges along the represented road segment, and so on.

FIG. 10 also shows some of the components of the node data record 1004 contained in the map database 120. Each of the node data records 1004 may have associated information (such as “attributes”, “fields”, etc.) that allows identification of the road segment(s) that connect to it and/or it is geographic position (e.g., its latitude and longitude coordinates). For the embodiment shown in FIG. 10, the node data records 1004A and 1004B include the latitude and longitude coordinates 1004A1 and 1004A1 for their nodes. The node data records 1004A and 1004B may also include other data 1004A2 and 1004B2 that refer to various other attributes of the nodes.

Thus, the overall data stored in the map database 120 may be organized in the form of different layers for greater detail, clarity, and precision. Specifically, in the case of high-definition maps, the map data may be organized, stored, sorted, and accessed in the form of three or more layers. These layers may include road level layer, lane level layer and localization layer. The data stored in the map database 120 in the formats shown in FIGS. 9 and 10 may be combined in a suitable manner to provide these three or more layers of information. In some embodiments, there may be lesser or fewer number of layers of data also possible, without deviating from the scope of the present disclosure.

FIG. 11 illustrates a block diagram 1100 of the map database 120 storing map data or geographic data 1104 in the form of road segments/links, nodes, and one or more associated attributes as discussed above. Furthermore, attributes may refer to features or data layers associated with the link-node database, such as an HD lane data layer.

In addition, the geographical data 1104 may also include other kinds of data 1106. The other kinds of data 1106 may represent other kinds of geographic features or anything else. The other kinds of data may include point of interest data. For example, the point of interest data may include point of interest records comprising a type (e.g., the type of point of interest, such as restaurant, ATM, etc.), location of the point of interest, a phone number, hours of operation, etc. The map database 120 also includes indexes 1102. The indexes 1102 may include various types of indexes that relate the different types of data to each other or that relate to other aspects of the data contained in the geographic database 106B.

The data stored in the map database 120 in the various formats discussed above may help in providing precise data for high-definition mapping applications, autonomous vehicle navigation and guidance, cruise control using ADAS, direction control using accurate vehicle maneuvering and other such services. In some embodiments, the system 102 accesses the map database 120 storing data in the form of various layers and formats depicted in FIG. 9, FIG. 10, and FIG. 11.

Various embodiments of the present disclosure may generate Lane-level demand values. Various embodiments of the present disclosure may receive, from one or more data sources, trip data associated with a plurality of trips. The plurality of trips is associated with a link segment of a geographical region. Various embodiments of the present disclosure may identify one or more trips from the plurality of trips associated with a lane of the link segment based on the trip data. Various embodiments of the present disclosure may determine location data 110 associated with the one or more trips based on the trip data. The location data 110 comprises one or more origin locations and one or more destination locations. Various embodiments of the present disclosure may generate one or more subsets 112 of the one or more trips. Each of the one or more subsets 112 is associated with at least one of: a respective origin location from the one or more origin locations, or a respective destination location from the one or more destination locations. Each of the one or more subsets 112 comprises at least one trip from the one or more trips. Various embodiments of the present disclosure may generate a demand value 114 for each of the one or more origin locations and each of the one or more destination locations based on the one or more subsets 112. Various embodiments of the present disclosure may output the demand value 114 associated with the lane.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a memory configured to store computer-executable instructions; and
one or more processors coupled to the memory, wherein the one or more processors are configured to execute the computer-executable instructions to cause the system to:
receive, from one or more data sources, trip data associated with a plurality of trips, wherein each of the plurality of trips is associated with a lane of a link segment within a geographical region;
determine location data associated with each of the plurality of trips based on the trip data, wherein the location data comprises an origin location and a destination location;
generate one or more subsets associated with the plurality of trips, wherein each of the one or more subsets is associated with at least one of: an origin location from the origin location of each of the plurality of trips, a destination location from the destination location of each of the plurality of trips, or a combination thereof, and wherein each of the one or more subsets comprises one or more trips from the plurality of trips;
generate a demand value for each of the origin location of each of the plurality of trips and each of the destination location of each of the plurality of trips based on the one or more subsets; and
output the demand value, wherein the demand value is associated with the lane.

2. The system of claim 1, wherein the one or more processors are further configured to execute the computer-executable instructions to cause the system to:
determine a trip count for each of the one or more subsets based on a number of the one or more of trips associated with each of the one or more subsets;
generate OD matrix data for each of the origin location of each of the plurality of trips and each of the destination location of each of the plurality of trips, based on the trip count for each of the one or more subsets; and
output the OD matrix data for the lane of the link segment.

3. The system of claim 1, wherein the one or more processors are further configured to:
generate one or more first subsets associated with the origin location of each of the plurality of trips, wherein each of the one or more first subsets are associated with the each of the origin location of each of the plurality of trips;
determine a trip count for each of the one or more first subsets; and
determine the demand value for each of the origin location of the plurality of trips based on the trip count of the corresponding first subset from the one or more first subsets.

4. The system of claim 1, wherein the one or more processors are further configured to execute the computer-executable instructions to cause the system to:
generate one or more second subsets associated with the destination location of each of the plurality of trips, wherein each of the one or more second subsets are associated with each of the destination location of each of the plurality of the trips;
determine a trip count for each of the one or more second subsets; and
determine the demand value for each of the destination location of the plurality of trips based on the trip count of the corresponding second subset from the one or more second subsets.

5. The system of claim 1, wherein the one or more processors are further configured to execute the computer-executable instructions to cause the system to:
determine an origin-destination (OD) pair from the plurality of trips based on the location data; and
generate the one or more subsets of the one or more trips based on each of the OD pairs associated with each of the plurality of trips.

6. The system of claim 5, wherein the one or more processors are further configured to execute the computer-executable instructions to cause the system to:
generate one or more third subsets associated with the OD pair for each of the plurality of the trips, wherein each of the one or more third subsets are associated with the each OD pair of each of the plurality of trips;
determine a trip count for each of the one or more third subsets; and
determine a demand value for each of the OD pair of each of the plurality of trips based on the trip count of the corresponding third subset from the one or more third subsets.

7. The system of claim 6, wherein the one or more processors are further configured to:
rank at least one of: each of the origin location of each of the plurality of trips, each of the destination location of each of the plurality of trips, or each of the OD pairs based on the demand value; and
generate one or more sets of ranked results based on the ranking, wherein each of the one or more sets of ranked results comprises a corresponding sequence associated with at least one of: origin location, destination location, or OD pairs.

8. The system of claim 1, wherein the one or more processors are further configured to execute the computer-executable instructions to cause the system to:
receive map data indicating lane information associated with the link segment; and
identify the one or more trips from the plurality of trips associated with the lane of the link segment based on the trip data and the map data.

9. The system of claim 1, wherein the one or more trips are associated with a predefined historical time period, and wherein the one or more processors are further configured to: execute the computer-executable instructions to cause the system to
determine a total trip count of the lane for the predefined historical time period based on the plurality of trips; and
output the determined total trip count for the lane.

10. The system of claim 1, wherein the one or more trips are associated with a predefined historical time period, and wherein the one or more processors are further configured to:
determine travel time data associated with each of the plurality of trips based on the trip data; and
determine average travel time for the lane during the predefined historical time period based on the determined travel time data.

11. The system of claim 1, wherein the link segment comprises a plurality of lanes, and wherein the one or more processors are further configured to:
generate a demand value for each of the origin locations of each of the plurality of trips and each of the destination locations of each of the plurality of trips associated with each of the plurality of lanes.

12. The system of claim 11, wherein the link segment comprises a plurality of lanes, and wherein the one or more processors are further configured to:
obtain vehicle data of a vehicle associated with the link segment; and
generate navigation instructions for the vehicle based on the demand value for each of the origin location of the plurality of trips and each of the destination location of the plurality of trips associated with each of the plurality of lanes.

13. The system of claim 1, wherein the one or more processors are further configured to identify the one or more trips from the plurality of trips associated with the lane using a lane-level map matcher model.

14. A method comprising:
receiving, from one or more data sources, trip data associated with a plurality of trips, wherein each of the plurality of trips is associated with a lane of a link segment within a geographical region;
determining location data associated with each of the plurality of trips based on the trip data, wherein the location data comprises an origin location and a destination location;
generating one or more subsets associated with the plurality of trips, wherein each of the one or more subsets is associated with at least one of: an origin location from the origin location of each of the plurality of trips, a destination location from the destination location of each of the plurality of trips, or a combination thereof, and wherein each of the one or more subsets comprises one or more trips from the plurality of trips
generating a demand value for each of the origin location of each of the plurality of trips and each of the destination location of each of the plurality of trips based on the one or more subsets; and
outputting the demand value associated with the lane.

15. The method of claim 14, further comprising:
generating one or more first subsets associated with the origin location of each of the plurality of trips, wherein each of the one or more first subsets are associated with the each of the origin location of each of the plurality of trips;
determining a trip count for each of the one or more first subsets; and
determining the demand value for each of the origin location of the plurality of trips based on the trip count of the corresponding first subset from the one or more first subsets.

16. The method of claim 14, further comprising:
generating one or more second subsets associated with the destination location of each of the plurality of trips, wherein each of the one or more second subsets are associated with each of the destination location of each of the plurality of the trips;
determining a trip count for each of the one or more second subsets; and
determining the demand value for each of the destination location of the plurality of trips based on the trip count of the corresponding second subset from the one or more second subsets.

17. The method of claim 14, further comprising:
determining a trip count for each of the one or more subsets based on the at least one trip associated with each of the one or more subsets;
generating the demand value for each of the origin locations of the plurality of trips and each of the destination location of each of the plurality of trips based on the trip count for each of the one or more subsets; and
outputting the at least one of: the origin location, or the destination location for the lane in association with the trip count of a corresponding subset from the one or more subsets.

18. The method of claim 14, further comprising:
determining each of a origin-destination (OD) pair associated with the plurality of trips based on the location data; and
generating one or more third subsets associated with the OD pair for each of the plurality of the trips, wherein each of the one or more third subsets are associated with the each OD pair of each of the plurality of trips;
determining a trip count for each of the one or more third subsets; and
determining a demand value for each of the OD pair of each of the plurality of trips based on the trip count of the corresponding third subset from the one or more third subsets.

19. The method of claim 18, further comprising:
ranking at least one of: each of the origin location of each of the plurality of trips, each of the destination location of each of the plurality of trips, or each of the OD pairs based on the demand value; and
generating one or more sets of ranked results based on the ranking, wherein each of the one or more sets of ranked results comprises a corresponding sequence associated with at least one of: origin location, destination location, or OD pairs.

20. A computer programmable product comprising a non-transitory computer readable medium having stored thereon computer executable instructions, which when executed by one or more processors, cause the one or more processors to carry out operations comprising:
receiving, from one or more data sources, trip data associated with a plurality of trips, wherein each of the plurality of trips is associated with a lane of a link segment within a geographical region;
determining location data associated with each of the plurality of trips based on the trip data, wherein the location data comprises an origin location and a destination location;
generating one or more subsets associated with the plurality of trips, wherein each of the one or more subsets is associated with at least one of: an origin location from the origin location of each of the plurality of trips, a destination location from the destination location of each of the plurality of trips, or a combination thereof, and wherein each of the one or more subsets comprises one or more trips from the plurality of trips;
generating a demand value for each of the origin location of each of the plurality of trips and each of the destination location of each of the plurality of trips based on the one or more subsets; and
outputting the demand value associated with the lane.
